(19) United States
(12) Patent Application Publication
(10) Pub. No.: US 2024/0134958 A1
(43) Pub. Date: Apr. 25, 2024

(54) DEVICE CONTROL PERMISSION SETTING METHOD AND APPARATUS, AND COMPUTER DEVICE AND STORAGE MEDIUM

(71) Applicant: SHENZHEN TCL NEW TECHNOLOGY CO., LTD., Shenzhen (CN)

(72) Inventor: Hui LI, Shenzhen (CN)

(73) Assignee: SHENZHEN TCL NEW TECHNOLOGY CO., LTD., Shenzhen (CN)

(21) Appl. No.: 18/399,721

(22) Filed: Dec. 29, 2023

Related U.S. Application Data
(63) Continuation of application No. PCT/CN2022/094889, filed on May 25, 2022.

(30) Foreign Application Priority Data
Jul. 25, 2021 (CN) 202110844672.0

(51) Int. Cl. G06F 21/45

(52) U.S. Cl. CPC G06F 21/45

(57) ABSTRACT

The present application discloses a device control permission setting method and apparatus, and a computer device and a storage medium. The method includes: obtaining device authentication information of a second Internet of Things device which belongs to a different Internet of Things system from a first Internet of Things device, and authenticating the second Internet of Things device on the basis of the device authentication information; and if the authentication is passed, obtaining device control information of the second Internet of Things device, and setting a device control permission of the second Internet of Things device to the first Internet of Things device on the basis of the device control information.

### CROSS-REFERENCE TO RELATED APPLICATION

This application claims priority to Chinese Patent Application No. 202110844672.0, filed on Jul. 26, 2021, entitled “DEVICE CONTROL PERMISSION SETTING METHOD AND APPARATUS, AND COMPUTER DEVICE AND STORAGE MEDIUM”, the disclosure of which is incorporated herein by reference in its entirety.

### TECHNICAL FIELD

The present application relates to the field of Internet technologies, and more particularly to a method and apparatus for setting a device control authority, a computer device, and a storage medium.

### BACKGROUND

The Internet of Things (IoT), i.e., Internet of Everything, is a huge network formed by combining various information sensing devices with a network, so that interconnection and intercommunication between people, machines, and objects can be realized at anytime, anywhere. An Internet of Things device is composed of a hardware and a software system thereon, and device control of the Internet of Things device can be realized by setting a device control authority of the Internet of Things device.

### SUMMARY

An embodiment of the present application provides a method for setting a device control authority, including:
obtaining device authentication information of a second Internet of Things device that belongs to a different Internet of Things system from a first Internet of Things device;
authenticating the second Internet of Things device based on the device authentication information of the second Internet of Things device;
in response to the authentication being passed, obtaining device control information of the second Internet of Things device; and
setting a device control authority of the second Internet of Things device for the first Internet of Things device based on the device control information.

Correspondingly, another embodiment of the present application further provides a computer device, including: a memory, a processor, and a computer program stored on the memory and operable on the processor, where the computer program, when executed by the processor, implements steps of the method for setting the device control authority as shown in any one of the embodiments of the present application.

According to the embodiments of the present application, the device authentication information of the second Internet of Things device that belongs to the different Internet of Things system from the first Internet of Things device can be obtained; the second Internet of Things device can be authenticated based on the device authentication information of the second Internet of Things device; in response to the authentication being passed, the device control information of the second Internet of Things device can be obtained; and the device control authority of the second Internet of Things device for the first Internet of Things device can be set based on the device control information.

### DESCRIPTION OF THE DRAWINGS

FIG. 1 is a schematic diagram of a scenario of a method for setting a device control authority according to some embodiments of the present application.

FIG. 2 is a flow diagram of a method for setting a device control authority according to some embodiments of the present application.

FIG. 3 is an interactive schematic diagram of a method for setting a device control authority according to some embodiments of the present application.

FIG. 4 is another interactive schematic diagram of a method for setting a device control authority according to some embodiments of the present application.

FIG. 5 is another interactive schematic diagram of a method for setting a device control authority according to some embodiments of the present application.

FIG. 6 is another interactive schematic diagram of a method for setting a device control authority according to some embodiments of the present application.

FIG. 7 is another flow diagram of a method for setting a device control authority according to some embodiments of the present application.

FIG. 8 is another flow diagram of a method for setting a device control authority according to some embodiments of the present application.

FIG. 9 is a timing schematic diagram of a method for setting a device control authority according to some embodiments of the present application.

FIG. 10 is a schematic structural diagram of a computer device according to some embodiments of the present application.

### DETAILED DESCRIPTION

Technical solutions in embodiments of the present application will be clearly and completely described below in conjunction with drawings in the embodiments of the present application. Obviously, the described embodiments are only a part of embodiments of the present application, rather than all the embodiments. Based on the embodiments in the present application, all other embodiments obtained by those skilled in the art without creative work fall within the protection scope of the present application.

Embodiments of the present application provide a method and apparatus for setting a device control authority, a computer device, and a storage medium. Specifically, an embodiment of the present application provides an apparatus for setting a device control authority applicable to a first computer device (which may be referred to as a first setting apparatus for distinguishing), and an apparatus for setting a device control authority applicable to a second computer device (which may be referred to as a second setting apparatus for distinguishing). The first computer device may be a device such as a terminal, which may be a mobile phone, a tablet computer, a notebook computer, an Internet of Things device, or the like. For example, the Internet of Things device may include an intelligent sound box, an intelligent television, an intelligent refrigerator, an intelligent water heater, or the like. The second computer device may be a device such as a terminal, which may be a mobile phone, a tablet computer, a notebook computer, an Internet of Things device, or the like. For example, the Internet of Things device may include an intelligent sound box, a gateway, an intelligent television, a router, or the like.

An example in which the first computer device is used as one terminal and the second computer device is used as another terminal is taken in any one of the embodiments of the present application, to introduce a method for setting a device control authority.

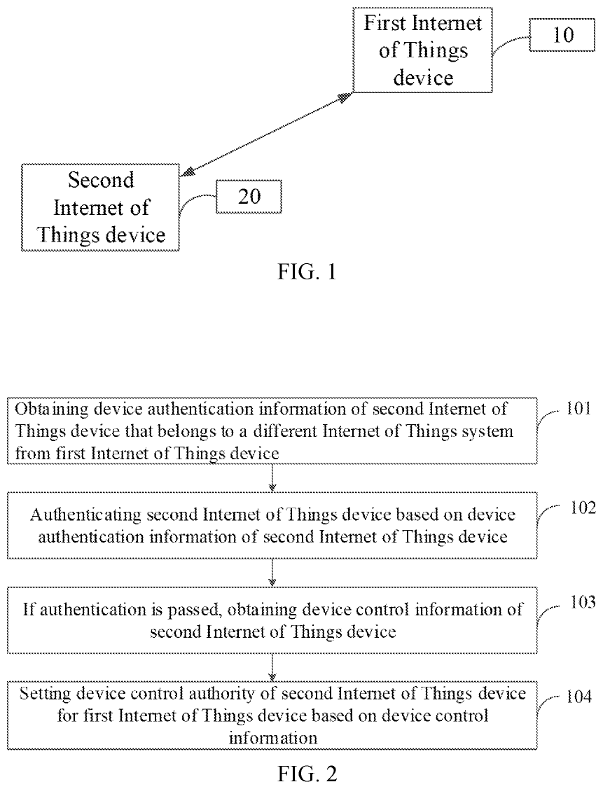

Referring to FIG. 1, an embodiment of the present application provides a system for setting a device control authority, including a first Internet of Things device 10, a second Internet of Things device 20, and the like. The first Internet of Things device 10 and the second Internet of Things device 20 are connected over a network, for example, through a wired or wireless network connection, or the like, where the apparatus for setting the device control authority is integrated in a terminal. For example, the apparatus in the form of a client is integrated in a terminal.

The first Internet of Things device 10 may obtain device authentication information of the second Internet of Things device 20 that belongs to different Internet of Things system from the first Internet of Things device 10, and authenticate the second Internet of Things device 20 based on the device authentication information. Correspondingly, the second Internet of Things device 20 may obtain device authentication information of the first Internet of Things device 10 that belongs to different Internet of Things system from the second Internet of Things device 20, and authenticate the first Internet of Things device 10 based on the device authentication information. As such, the first Internet of Things device 10 and the second Internet of Things device 20 can be mutually authenticated with each other.

Further, in response to the authentication being passed, the second Internet of Things device 20 can transmit device control information to the first Internet of Things device 10, where the device control information is configured to instruct the first Internet of Things device 10 to set a control authority, the control authority being a device control authority of the second Internet of Things device 20 for the first Internet of Things device 10. Correspondingly, the first Internet of Things device 10 may obtain device control information of the second Internet of Things device 20 and set a device control authority of the second Internet of Things device 20 for the first Internet of Things device 10 based on the device control information.

Alternatively, the second Internet of Things device 20 can transmit a device control instruction to the first Internet of Things 10, so that the second Internet of Things device 20 can perform device control for the first Internet of Things 10 via the device control instruction. Correspondingly, the first Internet of Things 10 can receive a device control instruction transmitted by the second Internet of Things device 20 and perform an operation corresponding to the device control instruction.

Detailed descriptions are given below. It should be noted that the description order of the following embodiments is not intended to limit the preferred order of the embodiments.

The present embodiment will be described from the perspective of a first setting apparatus, which may be specifically integrated in a terminal.

A method for setting a device control authority provided in the embodiment of the present application can be performed by a processor of the terminal. As shown in FIG. 2, the method for setting the device control authority may include steps 101-104 as follows.

At step 101, device authentication information of a second Internet of Things device that belongs to a different Internet of Things system from a first Internet of Things device may be obtained.

The Internet of Things (IOT) refers to collecting in real time any object or process to be monitored, connected, or interacted by various devices and technologies, such as various information sensors, radio frequency identification technologies, global positioning systems, infrared sensors, or laser scanners, collecting various required information such as sound, light, heat, electricity, mechanics, chemistry, biology, or location of the object and process, realizing ubiquitous connection between one object and another object or between an object and human via various possible network access, and realizing intelligent sensing, identification, and management of the object and the process. The Internet of Things is an information carrier based on the Internet, as well as conventional telecommunications networks, etc., which enables all ordinary physical objects that can be independently addressed to form an interconnected and intercommunicated network.

An Internet of Things device refers to a device having a sensor detection function or an access device having an intelligent function in the Internet of Things. For example, a device supporting a temperature detecting sensor or a home intelligent device (which may be an intelligent home system composed of multiple devices) may simultaneously support certain control functions, such as a restart, firmware upgrade, and the like. For example, the Internet of Things device may include an intelligent sound box, an intelligent television, an intelligent air conditioner, an intelligent refrigerator, an intelligent water heater, a gateway, a router, a floor sweeping robot, or the like. In particular, the Internet of Things device may be a terminal device such as a mobile phone, a tablet computer, or a notebook computer. The terminal device may have an Internet of Things client running thereon. As an example, the client may include a browser application (also referred to as a Web application), an Application (APP), an applet, and the like.

The Internet of Things system is an integrated system platform for realizing interconnection and intercommunication, and Internet of Things objects belonging to the same Internet of Things system can interact by following a data interaction criterion of the Internet of Things system. For example, compared with cross Internet of Things systems, for an APP, a cloud server, an Internet of Things device, a service, and the like in the same Internet of Things system, they may have related authority of data interaction because they are Internet of Things objects in the same Internet of Things system, so that the Internet of Things objects in the same Internet of Things system may perform data interaction more quickly.

In a practical application, Internet of Things objects belonging to the same Internet of Things system may be referred to as Internet of Things object belonging to the same Internet of Things ecology, or Internet of Things objects belonging to the same ecology. For example, for an Internet of Things system including an application, a cloud server, an Internet of Things device, a service, and the like constructed by an organization subject, an Internet of Things object in the Internet of Things system may be considered as an Internet of Things object in an Internet of Things ecology constructed by the organization subject. The organization subject may be a single subject, for example, a manufacturer, a factory, a brand, or the like. The organization subject may be an organization formed by a plurality of subjects, for example, an alliance organization formed by negotiation of a plurality of manufacturers.

The first Internet of Things device in the present application is an Internet of Things device to be controlled by the second Internet of Things device. As an example, in an application scenario of an intelligent home, the first Internet of Things device may be an intelligent home appliance provided by a manufacturer A; and in an application scenario of intelligent security, the first Internet of Things device may be an intelligent security device provided by the manufacturer A; and so on.

The second Internet of Things device in the present application is an Internet of Things device of the first Internet of Things device is to be controlled, and the second Internet of Things device and the first Internet of Things device belong to different Internet of Things system. For example, for the first Internet of Things device, one case of the second Internet of Things device may be a third party local hub, where the “third party” is used to emphasize that the second Internet of Things device and the first Internet of Things device belong to different Internet of Things systems, for example, the second Internet of Things device and the first Internet of Things device are Internet of Things devices belonging to different manufacturers; and “local hub” is used to emphasize that the second Internet of Things device is a local device that can control and manage the first Internet of Things device.

It should be noted that the Internet of Things system to which the second Internet of Things device belongs may be provided with an Internet of Things App for the second Internet of Things device, and the Internet of Things App and the first Internet of Things device belong to different Internet of Things systems. In some embodiments, the second Internet of Things device may control the first Internet of Things device by performing the steps in the method for setting the device control authority described in the present application via an Internet of Things App corresponding to the second Internet of Things device. That is, the third party local hub may be in the form of an Internet of Things App in addition to the Internet of Things device. As such, the second Internet of Things device in the present application is a terminal device running the Internet of Things App. For example, the terminal device may include a mobile phone, a tablet computer, a notebook computer, and the like.

The device authentication information is information required for the first Internet of Things device to authenticate the second Internet of Things device. For example, the first Internet of Things device may determine the reliability of the second Internet of Things device by authenticating the second Internet of Things device, so as to ensure security of subsequent device control.

There may be a variety of forms of the device authentication information. For example, the device authentication information may be authorization information determined by negotiation between one Internet of Things system to which the first Internet of Things device belongs (which may be referred to as the first Internet of Things system for purpose of distinguishing) and another Internet of Things system to which the second Internet of Things device belongs (which may be referred to as the second Internet of Things system for purpose of distinguishing), where the authorization information represents mutual authentication between the first Internet of Things system and the second Internet of Things system.

For another example, the device authentication information may be to-be-authenticated information transmitted by the second Internet of Things device. After receiving the to-be-authenticated information, the first Internet of Things device still needs to perform further authentication on the to-be-authenticated information to determine a device authentication result of the second Internet of Things device. As an example, the authentication process may be implemented based on an authentication mechanism of a challenge/response, and the device authentication information obtained by the first Internet of Things device may be a response value Rca generated by the second Internet of Things device based on a challenge value Rc transmitted by the first Internet of Things device.

There may be multiple manners in which the first Internet of Things device obtains the device authentication information. For example, a connection relationship between the first Internet of Things device and the second Internet of Things device can be established and the device authentication information can be obtained based on the connection relationship. Specifically, the step of “obtaining device authentication information of a second Internet of Things device that belongs to a different Internet of Things system from a first Internet of Things device” may include:
establishing a connection relationship between the first Internet of Things device and the second Internet of Things device, where the first Internet of Things device and the second Internet of Things device belong to different Internet of Things systems; and
obtaining device authentication information of the second Internet of Things device based on the connection relationship.

It should be noted that the connection relationship established here is a connection relationship in a configuration process. Specifically, a process in which the second Internet of Things device performs device control for the first Internet of Things device may include both configuration and control. The configuration process refers to steps having completed before steps required for implementation of control. For example, the configuration process may include steps such as network distribution and connection.

There may be multiple manners of establishing the connection relationship between the first Internet of Things device and the second Internet of Things device. For example, the connection relationship can be implemented by exchanging a key, for example, by exchanging a Personal Identification Number (PIN) code. Specifically, the first Internet of Things device and the second Internet of Things device may establish an encrypted connection relationship by performing security negotiation via a known PIN code.

As an example, the key exchanging solution may be implemented by PreSharedKey (PSK) as defined in the Datagram Transport Layer Security (DTLS). For another example, the key exchanging solution may be implemented in conjunction with an Elliptic Curve Diffie-Hellman key Exchange (ECDH) algorithm and the PIN code, and so on.

After the connection relationship between the first Internet of Things device and the second Internet of Things device is established, the device authentication information of the second Internet of Things device can be further obtained based on the connection relationship. As an example, after the connection relationship between the first Internet of Things device and the second Internet of Things device is established, i.e., a connection channel for data interaction between the first Internet of Things device and the second Internet of Things device may be established, the first Internet of Things device and the second Internet of Things device may perform data interaction via the connection channel, for example, transmitting device authentication information and receiving the device authentication information.

In some embodiments, taking into account such a case that the first Internet of Things device can correspond to a plurality of second Internet of Things devices to be established a connection relationship therewith to control the first Internet of Things device, the first Internet of Things device may determine a target second Internet of Things device from the plurality of second Internet of Things devices and establish a connection with the target second Internet of Things device. Specifically, the step of “establishing a connection relationship between the first Internet of Things device and the second Internet of Things device” can include:
receiving connection interrogation information transmitted by the second Internet of Things device; and
in response to information format of the connection interrogation information meeting a preset interrogation format, establishing a connection relationship between the first Internet of Things device and the second Internet of Things device.

The connection interrogation information is information transmitted by the second Internet of Things device, which is used to query whether the first Internet of Things device establishes a connection relationship with the second Internet of Things device. Formats of the connection interrogation information may include a variety of formats. For example, the connection interrogation information may in a form of a packet, such as a multicast packet, a broadcast packet, or the like.

In a practical application, the first Internet of Things device may receive the connection interrogation information transmitted by the second Internet of Things device after being in a network distribution state. For example, the first Internet of Things system may be configured with an Internet of Things App (which may be referred to as the first Internet of Things App for differentiation) for the first Internet of Things device, and a user may enable the first Internet of Things device to enter the network distribution state via the first Internet of Things App. For another example, the user may directly interact with the first Internet of Things device, for example, by triggering a physical control of the first Internet of Things device, or by voice calling to interact with the first Internet of Things device, so that the first Internet of Things device enters the network distribution state. For another example, the first Internet of Things device may always be in the network distribution state; and so on.

As an example, after entering the network distribution state, the first Internet of Things device may enter a mode of a pre-agreed listening port, so that the first Internet of Things device may listen for a broadcast packet in a local area network. Correspondingly, the second Internet of Things device may transmit a multicast packet or a broadcast packet in the local area network by means of the multicast packet or the like, so as to transmit the connection interrogation information to the first Internet of Things device. As such, the first Internet of Things device can receive the connection interrogation information transmitted by the second Internet of Things device.

In the present application, taking into account such a case that the first Internet of Things device can receive connection interrogation information transmitted by the plurality of second Internet of Things devices, a preset interrogation format can be set for the connection interrogation information in an application scenario in which device control is performed across Internet of things systems. As such, if the connection interrogation information of one of the second Internet of Things devices received by the first Internet of Things device meets the preset interrogation format, a connection relationship between the first Internet of Things device and the second Internet of Things device is established.

In one embodiment, after the first Internet of Things device has received the connection interrogation request transmitted by the second Internet of Things device and meeting the preset interrogation format, the first Internet of Things device may generate interrogation response information for the connection interrogation information, so that the second Internet of Things device may be informed of a response of the first Internet of Things device to the connection interrogation information by transmitting the connection response information to the second Internet of Things device. As such, both the first Internet of Things device and the second Internet of Things device may determine the connection relationship between the first Internet of Things device and the second Internet of Things device to be established. In this consensus, the first Internet of Things device and the second Internet of Things device may establish the connection relationship between the first Internet of Things device and the second Internet of Things device. Specifically, “establishing a connection relationship between the first Internet of Things device and the second Internet of Things device” can include:
generating interrogation response information of the connection interrogation information, where the interrogation response information includes device information of the first Internet of Things device; and
transmitting the interrogation response information to the second Internet of Things device to establish a connection relationship between the first Internet of Things device and the second Internet of Things device based on the device information.

The device information of the first Internet of Things device may include information such as a device identification of the first Internet of Things device and a system identification of the first Internet of Things system. The first Internet of Things device may generate interrogation response information carrying its device information to enable the second Internet of Things device to learn the response of the first Internet of Things device to its connection interrogation request.

In the present application, similar to the connection interrogation information, an interrogation response format can be set for interrogation response information in an application scenario in which device control is performed across the Internet of things systems Therefore, after receiving the connection interrogation information that is transmitted by the second Internet of Things device and meets the preset interrogation format, the first Internet of Things device may generate interrogation response information that meets the interrogation response format, and the interrogation response information may carry the device information of the first Internet of Things device.

There may be multiple manners in which the first Internet of Things device may transmit the interrogation response information to the second Internet of Things device. For example, the first Internet of Things device may reply to the second Internet of Things device via uni cast.

Similar to the case that the first Internet of Things device may receive connection interrogation information from the plurality of second Internet of Things devices, each of the second Internet of Things device may further transmit connection interrogation information to a plurality of first Internet of Things devices, so that the second Internet of Things device may receive connection response information from the plurality of first Internet of Things devices. Since the connection response information includes the device information of the first Internet of Things devices, the second Internet of Things device may determine one of the first Internet of Things devices with which the second Internet of Things device decides to establish a connection relationship based on the connection response information.

As such, the first Internet of Things device and the second Internet of Things device can establish a preliminary connection consensus by means of the connection interrogation information and the connection response information and further establish a connection relationship between the first Internet of Things device and the second Internet of Things device.

After the connection relationship between the first Internet of Things device and the second Internet of Things device is established in the present application, the connection relationship may be configured for the first Internet of Things device to authenticate the second Internet of Things device and for the second Internet of Things device to authenticate the first Internet of Things device. For example, the authentication process may be implemented based on an authentication mechanism of a challenge/response. Specifically, after the step of “establishing a connection relationship between the first Internet of Things device and the second Internet of Things device”, the apparatus for setting the device control authority can further include:
obtaining first authentication challenge information for the first Internet of Things device, where the first authentication challenge information is authentication challenge information of the second Internet of Things device for the first Internet of Things device;
generating device authentication information corresponding to the first Internet of Things device based on the first authentication challenge information, where the device authentication information is used for the second Internet of Things device to authenticate the first Internet of Things device; and
transmitting device authentication information corresponding to the first Internet of Things device to the second Internet of Things device to enable the second Internet of Things device to authenticate the first Internet of Things device based on the device authentication information corresponding to the first Internet of Things device.

The first authentication challenge information is authentication challenge information of the second Internet of Things device for the first Internet of Things device. Specifically, the second Internet of Things device may initiate an authentication challenge to the first Internet of Things device by transmitting the first authentication challenge information to the first Internet of Things device.

There may be multiple manners in which the first Internet of Things device may obtain the first authentication challenge information. For example, after the connection relationship between the first Internet of Things device and the second Internet of Things device is established, i.e., a connection channel for data interaction between the first Internet of Things device and the second Internet of Things device may be established, the second Internet of Things device may transmit first authentication challenge information to the first Internet of Things device through the connection channel. Correspondingly, the first Internet of Things device may obtain the first authentication challenge information through the connection channel.

As an example, the authentication challenge information of the second Internet of Things device for the first Internet of Things device, i.e., the first authentication challenge information can be represented as Rc1.

The device authentication information generated by the first Internet of Things device based on the first authentication challenge information is used as a response of authentication challenge initiated by the first Internet of Things device to the second Internet of Things device. Specifically, the device authentication information may be used for the second Internet of Things device to authenticate the first Internet of Things device.

There may be multiple manners of generating device authentication information corresponding to the first Internet of Things device based on the first authentication challenge information. For example, a device identification of the first Internet of Things device may be combined with the first authentication challenge information to obtain a combination result, and a hash value corresponding to the combination result is generated by a hash function and used as the device authentication information. For another example, the device identification, a preset shared key, and the first authentication challenge information of the first Internet of Things device may be spliced to obtain a splicing result, and then the generated splicing result is used as the device authentication information; and so on. A specific manner in which the first Internet of Things device generates the device authentication information based on the first authentication challenge information may be set based on a service requirement, which is not limited in the present application.

As an example, the device authentication information generated by the first Internet of Things device based on the first authentication challenge information may be represented as Rca1′.

Further, the first Internet of Things device can transmit device authentication information corresponding to the first Internet of Things device to the second Internet of Things device to enable the second Internet of Things device to authenticate the first Internet of Things device based on the device authentication information corresponding to the first Internet of Things device. For example, the first Internet of Things device may transmit device authentication information to the second Internet of Things device through the connection channel established with the second Internet of Things device.

In the present application, after the connection relationship between the first Internet of Things device and the second Internet of Things device is established, the first Internet of Things device can further obtain device authentication information of the second Internet of Things device based on the connection relationship, so as to implement authentication of the second Internet of Things device.

The device authentication information of the second Internet of Things device is related information required for the first Internet of Things device to authenticate the second Internet of Things device.

As an example, the process of device authentication may be implemented based on an authentication mechanism of a challenge/response, and then the first Internet of Things device may initiate an authentication challenge to the second Internet of Things device. The second Internet of Things device may transmit device authentication information to the first Internet of Things device as a response to the authentication challenge, and the device authentication information may be used for the first Internet of Things device to authenticate the second Internet of Things device.

There may be multiple authentication manners. For example, the authentication process may be implemented based on an authentication mechanism of a challenge/response. Specifically, the step of “obtaining device authentication information of the second Internet of Things device based on the connection relationship” can include:
determining second authentication challenge information for the second Internet of Things device, where the second authentication challenge information is authentication challenge information of the first Internet of Things device for the second Internet of Things device;
transmitting the second authentication challenge information to the second Internet of Things device; and
obtaining device authentication information generated by the second Internet of things device based on the second authentication challenge information.

The second authentication challenge information is authentication challenge information of the first Internet of Things device for the second Internet of Things device. Specifically, the first Internet of Things device may initiate an authentication challenge to the second Internet of Things device by transmitting the second authentication challenge information to the second Internet of Things device.

As an example, the second authentication challenge information of the first Internet of Things device for the second Internet of Things device may be represented as Rc.

There may be multiple manners in which the first Internet of Things device may transmit the second authentication challenge information to the second Internet of Things device. For example, the first Internet of Things device may transmit the second authentication challenge information to the second Internet of Things device by the connection channel established with the second Internet of Things device.

The device authentication information generated by the second Internet of Things device based on the second authentication challenge information is used as a response of challenge authentication initiated by the second Internet of Things device to the first Internet of Things device. Specifically, the device authentication information may be used for the first Internet of Things device to authenticate the second Internet of Things device.

As an example, the device authentication information generated by the second Internet of things device based on the second authentication challenge information may be represented as Rca.

There may be multiple manners in which the first Internet of Things device obtains the device authentication information generated by the second Internet of things device based on the second authentication challenge information. For example, the first Internet of Things device may obtain the device authentication information by the connection channel established with the second Internet of Things device.

In some embodiments, in order to improve the convenience and security of device authentication, a first authentication server paired with the first Internet of Things device and a second authentication server paired with the second Internet of Things device may be introduced, and the first authentication server and the second authentication server are mutual authentication servers. Specifically, the step of “obtaining device authentication information generated by the second Internet of Things device based on the second authentication challenge information” may include:
obtaining device authentication information generated by a first authentication server paired with the first Internet of Things device, where the device authentication information is generated based on the second authentication challenge information, the first authentication server and a second authentication server are mutual authentication servers, and the second authentication server is an authentication server paired with the second Internet of Things device.

The first authentication server is an authentication server paired with the first Internet of Things device, where the authentication server is a server for performing steps of a method related to device authentication. It should be noted in the present application that the pairing of the first authentication server with the first Internet of Things device means that the first authentication server has an authentication authority assigned to the first Internet of Things system, where the authentication authority indicates that the first Internet of Things system allows the first authentication server to perform steps of the method related to device authentication of the first Internet of Things device. Therefore, the first authentication server may belong to the same Internet of Things system as the first Internet of Things device, or may belong to a different Internet of Things system from the first Internet of Things device.

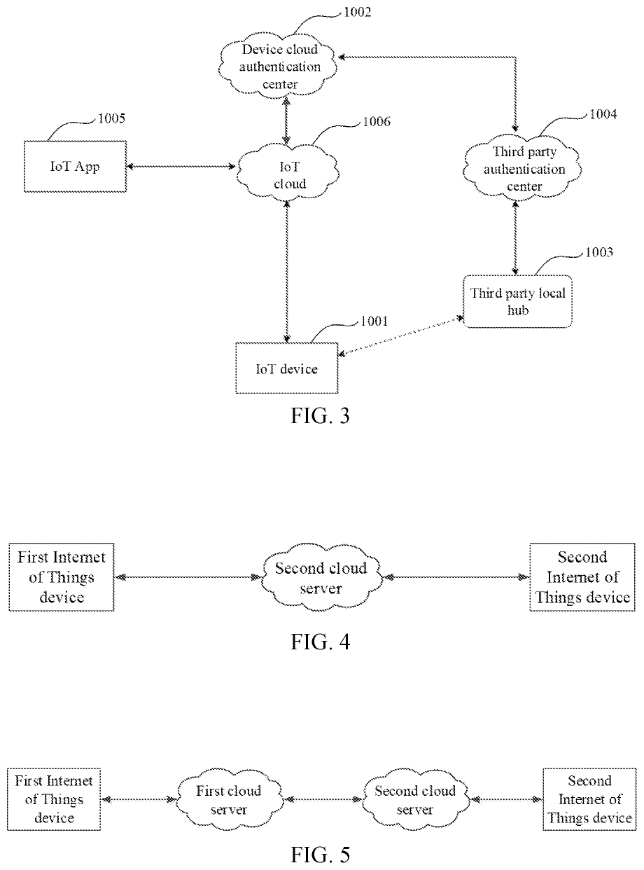

As an example, referring to FIG. 3, the first Internet of Things device may be an IoT device shown by 1001, and the first authentication server may be a device cloud authentication center shown by 1002.

The second authentication server is an authentication server paired with the second Internet of Things device. It should be noted similarly that Note that the pairing of the second authentication server with the second Internet of Things device means that the second authentication server has an authentication authority assigned to the second Internet of Things system, where the authentication authority indicates that the second Internet of Things system allows the second authentication server to perform steps of the method related to device authentication of the second Internet of Things device. Therefore, the second authentication server may belong to the same Internet of Things system as the second Internet of Things device, or may belong to a different Internet of Things system from the second Internet of Things device.

As an example, referring to FIG. 3, the second Internet of Things device may be a third party local hub shown by 1003, and the second authentication server may be a third party authentication center shown by 1004.

In the present application, the first authentication server and the second authentication server are mutual authentication servers. For example, the first authentication server and the second authentication server may be authenticated by Transport Layer Security (TLS) bidirectional certificates, and mutual identifications of the first authentication server and the second authentication server are confirmed. After the identifications are authenticated, the first authentication server and the second authentication server may determine their validity.

In some embodiments, the device authentication information generated by the second Internet of Things device based on the second authentication challenge information and obtained by the first Internet of Things device may be generated by the first authentication server based on the second authentication challenge information. Specifically, the second Internet of Things device may transmit the second authentication challenge information to the second authentication server, and further, the second authentication server may request challenge response corresponding to the second authentication challenge information from the first authentication server by transmitting the second authentication challenge information to the first authentication server. The first authentication server may generate the device authentication information based on the second authentication challenge information, and return the device authentication information to the second authentication server. Further, the second authentication server may return the device authentication information to the second Internet of Things device, so that the second Internet of Things device may return the device authentication information to the first Internet of Things device. As such, the first Internet of Things device may obtain the device authentication information generated by the second Internet of Things device based on the second authentication challenge information.

As an example, an example in which the second authentication challenge information is Rc and the device authentication information generated based on the second authentication challenge information is Rca is taken, and a process in which the first Internet of Things device authenticates the second Internet of Things device may be described with reference to FIG. 3. Specifically, the IoT device may initiate an authentication challenge to the third party local hub with a challenge value of Rc. The third party local hub may transmit Rc to the third party authentication center, which may request a challenge response of Rc from the device cloud authentication center. Since the device cloud authentication center and the third party authentication center are mutual authentication servers, the device cloud authentication center can return the challenge response Rca to the third party authentication center, which can then return the Rca to the third party local hub. Further, the third party local hub may return the Rca to the IoT device, so that the IoT device may obtain Rca.

At step 102, the second Internet of Things device may be authenticated based on the device authentication information of the second Internet of Things device.

There may be multiple manner in which that the first Internet of Things device may authenticate the second Internet of Things device based on the device authentication information of the second Internet of Things device. For example, the second Internet of Things device may be authenticated by verifying the device authentication information and determining the authentication result of the second Internet of Things device based on the verification result. Specifically, there may be multiple verification manners, for example, which may include comparing the device authentication information, calculating the device authentication information, querying and matching the device authentication information, and the like.

In some embodiments, the second Internet of Things device may be authenticated by verifying the device authentication information and determining the authentication result of the second Internet of Things device based on the verification result. Specifically, the step of “authenticating the second Internet of Things device based on the device authentication information of the second Internet of Things device” may include:
determining authentication verification information required for verifying the device authentication information; and
verifying the device authentication information based on the authentication verification information to authenticate the second Internet of Things device.

The authentication verification information is related information required for verifying the device authentication information and may be in multiple data forms. For example, the authentication verification information may be a character string, a value, or a collection and the like.

In the present application, the authentication verification information required for verifying the device authentication information may be determined according to a manner of verifying the device authentication information.

In some embodiments, a process in which the first Internet of Things device performs device authentication on the second Internet of Things device may be implemented based on an authentication mechanism of challenge/response, and a manner in which the first Internet of Things device verifies device authentication information of the second Internet of Things device may be implemented by information comparison. As an example, if the second authentication challenge information of the first Internet of Things device for the second Internet of Things device may be Rc, and the device authentication information generated by the second Internet of Things device based on the second authentication challenge information may be Rca, then the authentication verification information required for the first Internet of Things device to verify Rca may be Rca′ calculated by the first Internet of Things device based on Rc. Further, the first Internet of Things device can compare Rca′ with Rca to verify Rca. Specifically, if the comparison result is consistent, the first Internet of Things device can determine that the authentication result of the second Internet of Things device is that the authentication is passed, that is, it is determined that the second Internet of Things device is trusted. Otherwise, it is determined that the authentication result of the second Internet of Things device is that the authentication fails.

In another embodiment, verification of the device authentication information may be implemented by calculating the device authentication information. Therefore, the authentication verification information required for verifying the device authentication information may be preset value information, such as a preset value or a value range. As an example, the authentication verification information may be a preset value range, and the first Internet of Things device may calculate the device authentication information of the second Internet of Things device, and compare the calculation result with the preset value range to verify the device authentication information. Specifically, if the calculation result falls within the preset value range, the first Internet of Things device may determine that the authentication result of the second Internet of Things device is that the authentication is passed, that is, it is determined that the second Internet of Things device is trusted. Otherwise, it is determined that the authentication result of the second Internet of Things device is that the authentication fails.

In another embodiment, verification of the device authentication information may be implemented by querying and matching the device authentication information. Therefore, the authentication verification information required for verifying the device authentication information may be a preset information set, and at least one information element may be included in the set. For example, the set may include at least one piece of device verification information authenticated by the first Internet of Things device. Verification of the device authentication information may be implemented by querying whether there is an information element matching the device authentication information in the information set. Specifically, if there is an information element matching the device authentication information in the information set, the first Internet of Things device may determine that the authentication result of the second Internet of Things device is that the authentication is passed, that is, it is determined that the second Internet of Things device is trusted. Otherwise, it is determined that the authentication result of the second Internet of Things device is that the authentication fails.

At step 103, in response to the authentication being passed, device control information of the second Internet of Things device may be obtained.

The device control information of the second Internet of Things device is related information indicating that the first Internet of Things device sets a control authority, and the control authority is a device control authority of the second Internet of Things device to the first Internet of Things device.

In some embodiments, considering that the second Internet of Things device needs to learn the device capability of the first Internet of Things device before further generating the device control information, the device capability information of the first Internet of Things device may be transmitted to the second Internet of Things device before the first Internet of Things device obtains the device control information of the second Internet of Things device, so that the second Internet of Things device may further generate the device control information for the first Internet of Things device. Specifically, before the step of “obtaining of the device control information of the second Internet of Things device”, the apparatus for setting the device control authority can further include:
determining device capability information of the first Internet of Things device; and
transmitting the device capability information to the second Internet of Things device to trigger the second Internet of Things device to generate device control information for the first Internet of Things device based on the device capability information.

The device capability information of the first Internet of Things device is related information describing the device capability that can be provided by the first Internet of Things device. For example, the device capability information may include a specific model, a type, a controllable instruction, an attribute, a service, and the like of the device. It should be noted in a practical application that the device capability information of the first Internet of Things device may also be referred to as a capability model of the first Internet of Things device.

There may be multiple cases of triggering the first Internet of Things device to determine its device capability information. For example, the device capability request transmitted by the second Internet of Things device can be configured to trigger the first Internet of Things device to determine its device capability information. Specifically, the step of “determining the device capability information of the first Internet of Things device” may include:
obtaining a device capability request of the second Internet of Things device for the first Internet of Things device; and
determining device capability information of the first Internet of Things device based on the device capability request.

The device capability request is data for requesting to obtain a capability model of the first Internet of Things device.

In some embodiments, in order to ensure the security of the data interaction, the first Internet of Things device and the second Internet of Things device may make an agreement on a format of the device capability request, so that the second Internet of Things device may request to obtain a capability model of the first Internet of Things device by generating a device capability request meeting a preset agreement format and transmitting the device capability request to the first Internet of Things device.

After obtaining the device capability request transmitted by the second Internet of Things device, the first Internet of Things device can determine the device capability information of the first Internet of Things device and transmit the device capability information to the second Internet of Things device to trigger the second Internet of Things device to generate device control information for the first Internet of Things device based on the device capability information.

In the present application, there may be multiple manners in which the first Internet of Things device obtains the device authentication information of the second Internet of Things device. For example, the first Internet of Things device may receive the device control packet transmitted by the second Internet of Things device to extract the device control information of the second Internet of Things device from the device control packet. Specifically, the step of “obtaining the device control information of the second Internet of Things device” may include:
receiving device control packet transmitted by the second Internet of Things device; and
extracting device control information of the second Internet of things device from the device control packet.

The device control packet is packet data for transmitting the device control information.

In some embodiments, the second Internet of things device may transmit a device control packet to the first Internet of things device in a predetermined format, where the device control packet may include device control information of the second Internet of things device. Correspondingly, the first Internet of Things device may receive a device control packet transmitted by the second Internet of Things device, and extract the device control information of the second Internet of Things device from the device control packet. For example, the third party local hub may transmit a device control packet request to the IoT device in a predetermined format to request an Access Control Lists (ACL) to the IoT device. Correspondingly, the IoT device may receive the device control packet and extract device control information from the device control packet to set the ACL of the IoT device based on the device control information.

As an example, the first Internet of Things device may receive the device control packet transmitted by the second Internet of Things device through the connection relationship established in the configuration process. Specifically, after the connection relationship between the first Internet of Things device and the second Internet of Things device is established, i.e., a connection channel for data interaction between the first Internet of Things device and the second Internet of Things device may be established, the first Internet of Things device and the second Internet of Things device may perform data interaction via the connection channel, for example, transmitting device control packet and receiving the device control packet.

At step 104, a device control authority of the second Internet of Things device for the first Internet of Things device may be set based on the device control information.

Since the device control information of the second Internet of Things device is related information indicating that the first Internet of Things device sets a control authority being a device control authority of the second Internet of Things device for the first Internet of Things device, the first Internet of Things device may set the device control authority of the second Internet of Things device for the first Internet of Things device based on the obtained device control information.

There may be multiple manners of setting the device control authority of the second Internet of Things device for the first Internet of Things device based on the device control information. For example, related data of maintaining the device control authority in the first Internet of Things device may be modified based on the device control information, so that the first Internet of Things device may set the device control authority of the second Internet of Things device for the first Internet of Things device according to the modified related data. As an example, the setting of the device control authority of the second Internet of Things device for the first Internet of Things device may be implemented by setting Access Control Lists (ACL) of the first Internet of Things device based on the device control information.

The ACL is an access control technology based on packet filtering, which can filter packets on an interface according to a set condition, and allow the packets to pass or be discarded. The access control lists are widely applied to routers and layer-3 switches, and access of a user to a network can be effectively controlled by means of the access control lists, thereby ensuring network security to the maximum extent.

In some embodiments, considering that the second Internet of Things device and the first Internet of Things device belong to different Internet of Things systems, device control of the second Internet of Things device to the first Internet of Things device is essentially a device control performed across the Internet of Things systems. The device control object may implement device control of the first Internet of Things device via the second Internet of Things device. Therefore, the setting of the device control authority of the second Internet of Things device for the first Internet of Things device can be implemented by setting a device control authority of a device control object in a second Internet of Things system for the first Internet of Things device.

Specifically, the device control information includes a system identification of a target Internet of Things system and an object identification of a device control object, where the target Internet of Things system is an Internet of Things system to which the second Internet of Things device belongs, i.e., the second Internet of Things system, and the device control object is an object that controls a first Internet of Things device via the second Internet of Things device. Specifically, the step of “setting a device control authority of the second Internet of Things device for the first Internet of Things device based on the device control information” can include:
setting a device control authority of the device control object in the target Internet of Things system for the first Internet of Things device based on the system identification and the object identification.

The system identification is identification information for uniquely identifying the Internet of things system, and the system identification may be in a variety of forms, for example, may include different data forms such as a character string, an image, and an audio. In a practical application, the system identification of the target Internet of things system may be referred to as an ecological identification code of the target Internet of things system, which may be used to uniquely identify a third party manufacturer. For example, if the second Internet of Things device may be a third party local hub, correspondingly the system identification of the Internet of Things system to which the second Internet of Things device belongs is an ecological identification code of the third party local hub.

The object identification is identification information for uniquely identifying a device control object in the Internet of things system, and the object identification may be in a variety of forms, for example, may include different data forms such as a character string, an image, and an audio. The device control object is an object for controlling the first Internet of Things device. For example, the device control object may be a user, an Internet of Things device or the like. In a practical application, the object identification of the device control object may be referred to as a subject Identity Document (ID), where the subject ID may be used to uniquely identify a user or an Internet of Things device within a third party manufacturer (the Internet of Things device may act as a controller in an application scenario of device control) and may be unique within the third party manufacturer.

In a practical application, the second Internet of Things device may allocate different object identification to different device control objects in the target Internet of Things system. For example, the third party local hub may allocate different subject IDs to different controllers, users, etc., within its own ecology.

After determining the system identification of the target Internet of Things system and the object identification of the device control object, the first Internet of Things device may further set the device control authority of the device control object in the target Internet of Things system for the first Internet of Things device based on the system identification and the object identification.

As an example, if the system identification is an identification a corresponding to a manufacturer A and the object identification is an identification b corresponding to a user B in the device control information received by the first Internet of Things device, the first Internet of Things device may modify the ACL of the first Internet of Things device based on the identification a and the identification b. As such, the user B may set the device control authority for the first Internet of Things device. It should be noted that the device control authority provided here is a control authority for the first Internet of Things device owned by the user B in the Internet of things system corresponding to the manufacturer A.

As another example, if the system identification is an identification a corresponding to a manufacturer C and the object identification is an identification b corresponding to a user B in the device control information received by the first Internet of Things device, the first Internet of Things device may set a device control authority of the user B for the first Internet of Things device similarly. It should be noted that the device control authority provided here is a control authority for the first Internet of Things device owned by the user B in the Internet of things system corresponding to the manufacturer C.

As another example, if the system identification is an identification a corresponding to a manufacturer A and the object identification is an identification b corresponding to a controller D in the device control information received by the first Internet of Things device, the first Internet of Things device may set a device control authority of the controller D for the first Internet of Things device similarly. It should be noted that the control authority provided here is a control authority for the first Internet of Things device owned by the controller D in the Internet of things system corresponding to the manufacturer A.

In some embodiments, considering that, in an application scenario in which device control is performed across the Internet of things systems, a different authority may be allocated to each of device control objects in the target Internet of things system, and the authority may be embodied by an object attribute of the device control object. Therefore, the device control information obtained by the first Internet of things device may further include object attribute information of the device control object. Specifically, the step of “setting a device control authority of the device control object in the target Internet of Things system for the first Internet of things device based on the system identification and the object identification” can include:
determining a service calling authority of the device control object for the first Internet of Things device based on the object attribute information, where the service calling authority is a calling authority of the device control object for a service provided by the first Internet of Things device, and the service provided by the first Internet of Things device is determined based on the device capability information of the first Internet of Things device; and
setting a device control authority of the device control object in the target Internet of Things system for the first Internet of Things device based on the service calling authority.

The object attribute information is used to describe object attributes of the device control object, different object attributes represent different roles, and different roles represent different authority. For example, the authorities may include a service calling authority and an information changing authority. In the present application, each of the object identification of the device control object corresponds to one of the object attributes of the device control object, respectively. That is, in a practical application, each of the roles of the device control object corresponds to one of the subject IDs, respectively.

For example, if the object attribute of the device control object is role 1, it indicates that the device control object has only the service calling authority for the first Internet of Things device, and if the object attribute of the device control object is role 2, it indicates that the device control object has the service calling authority and the information changing authority for the first Internet of Things device. For another example, if the object attribute of the device control object is role 1, it indicates that the device control object has only the service calling authority for the first Internet of Things device; if the object attribute of the device control object is role 2, it indicates that the device control object has the information changing authority for the first Internet of Things device; and if the object attribute of the device control object is role 3, it indicates that the device control object has the service calling authority and the information changing authority for the first Internet of Things device; and so on.

In some embodiments, the object attribute of the device control object may include an administrator and an ordinary user. Specifically, if the object attribute of the device control object is the administrator, the device control object may have an information changing authority and a service calling authority for the first Internet of Things device; and if the object attribute of the device control object is the ordinary user, the device control object may have only the service calling authority for the first Internet of Things device.

The information changing authority represents a changing authority of the device control object for the device control information stored by the first Internet of Things device. For example, the information changing authority represents a changing authority of the device control object for the ACL of the first Internet of Things device.

The service calling authority is a calling authority of the device control object for a service provided by the first Internet of Things device, and the service provided by the first Internet of Things device is determined based on the device capability information of the first Internet of Things device. If the device control object has a service calling authority for the first Internet of Things device, the device control object can call a service authorized in the first Internet of Things device. For example, the first Internet of Things device may be an intelligent air conditioner, the service provided by the first Internet of Things device may include a refrigeration service, a dehumidification service, a heating service, and the like. If the device control object has a service calling authority for the intelligent refrigerator, the device control object can call a service authorized in the intelligent refrigerator.

Therefore, the first Internet of Things device may determine whether the device control object has a service calling authority for the first Internet of Things device based on the object attribute information of the device control object, so that the first Internet of Things device may further set a device control authority of the device control object in the target Internet of Things system for the first Internet of Things device.

As an example, if the first Internet of Things device may be an intelligent television, the device control object of the second Internet of Things device may be a child E, and the object attribute of the child E is an ordinary user, then, the intelligent television may determine that the child E has the service calling authority for the intelligent television based on the object attribute information of the child E, and set the device control authority of the child E in the target Internet of Things system for the intelligent television, including the service calling authority for the intelligent television.

In another embodiment, the device control information may further include service accessing information of the device control object, where the service accessing information includes an authorized access service of the device control object for the first Internet of Things device, and an access authority of the device control object for the authorized access service. Therefore, the first Internet of Things device may determine the service accessing authority of the device control object for the first Internet of Things device based on the service accessing information after determining that the device control object has the service calling authority for the first Internet of Things device, so as to further determine the service calling authority of the device control object for the first Internet of Things device. Specifically, the step of “determining a service calling authority of the device control object for the first Internet of Things device” can include:
determining a service accessing authority of the device control object for the first Internet of Things device based on the service accessing information.

As an example, the first Internet of Things device may be an intelligent television, the device control object of the second Internet of Things device may be a child E, the object attribute of the child E is an ordinary user, the service accessing information of the child E includes an authorized access service of the child E to the intelligent television and an access authority of the child E for the authorized access service. Specifically, the authorized access service of the child E to the intelligent television includes following two services: viewing a science and education channel, and viewing an animation channel, and the access authority of the child E for the “viewing a science and education channel” is two hours per day, and the access authority of the child E for the “viewing an animation channel” is one hour per day. Then, the intelligent television may determine the service accessing authority of the child E for the intelligent television based on the authorized access service of the child E and the access authority of the child E for the authorized access service, so as to further determine what service in the intelligent television the child E can specifically access and the specific authority of the child E for the accessible service on the basis of determining that the child E has the service calling authority for the intelligent television.

In another embodiment, if the object attribute information of the device control object indicates that the device control object further has the information changing authority for the first Internet of Things device, the first Internet of Things device may correspondingly set the device control authority of the device control object for the first Internet of Things device. Specifically, the step of “setting the device control authority of the device control object in the target Internet of Things system for the first Internet of Things device based on the service call authority” can include:
if the object attribute information indicates that the device control object has an information changing authority for the first Internet of Things device, setting a device control authority of the device control object in the target Internet of Things system to the first Internet of Things device based on the information changing authority and the service calling authority, where the information changing authority represents a changing authority of the device control object for the device control information stored in the first Internet of Things device.

As an example, if the first Internet of Things device may be an intelligent television, the device control object of the second Internet of Things device may be an adult F, and the object attribute of the adult F is an administrator, then, the intelligent television may determine that the adult F has the service calling authority and information changing authority for the intelligent television based on the object attribute information of the adult F, and set the device control authority of the adult F in the target Internet of Things system for the intelligent television, including the service calling authority and information changing authority for the intelligent television.

In a practical application, the device control information received by the first Internet of Things device may further include information such as a device ID, a connection key, and a key expiration time of the connection key, in addition to a system identification of an Internet of Things system to which the second Internet of Things device belongs, object identification of the device control object, object attribute information, and service accessing information.

The device ID is further referred to as a target device identification, which is a unique ID assigned by the target Internet of Things system for the first Internet of Things device and can be used to uniquely identify a device in the target Internet of Things system. The connection key may be used by the first Internet of Things device to establish a control connection with the second Internet of Things device, and each of the connection keys corresponds to one of the object identifications, respectively.

In a practical application, the second Internet of Things device may allocate information such as different object identification, keys, object attributes and the like to different device control objects in the target Internet of Things system. For example, the third party local hub may allocate information such as different subject Ids, keys, roles, and the like to different controllers, users, etc., within its own ecology.

The process of setting the device control authority is described above from the perspective of the first Internet of Things device. In a practical application, the device control may be further performed on the basis of the foregoing process. Specifically, the method for setting the device control authority may further include:
receiving a device control instruction transmitted by the second Internet of Things device, where the device control instruction is used by the second Internet of Things device to perform device control for the first Internet of Things device; and
executing an operation corresponding to the device control instruction.

In the present application, there may be multiple manners in which the first Internet of Things device receives the device control instruction transmitted by the second Internet of Things device. For example, in some embodiments, referring to FIG. 4, the second Internet of Things device may transmit the device control instruction to a second cloud server paired with the second Internet of Things device, and further the second cloud server may transmit the device control instruction to the first Internet of Things device so that the first Internet of Things device may receive the device control instruction transmitted by the second Internet of Things device. Specifically, the step of “receiving the device control instruction transmitted by the second Internet of Things device” may include:
receiving a device control instruction transmitted by a second cloud server paired with the second Internet of Things device, where the device control instruction is an instruction transmitted by the second Internet of Things device to the second cloud server.

It should be noted that the second cloud server paired with the second Internet of Things device may be a cloud server of the same Internet of Things system as the second Internet of Things device.

In another embodiment, referring to FIG. 5, the second Internet of Things device may transmit a device control instruction to a second cloud server paired with the second Internet of Things device, and the second cloud server may transmit the device control instruction to a first cloud server paired with the first Internet of Things device. Further, the first cloud server may transmit the device control instruction to the first Internet of Things device, so that the first Internet of Things device may receive the device control instruction transmitted by the second Internet of Things device. Specifically, the step of “receiving the device control instruction transmitted by the second Internet of Things device” may include:
receiving a device control instruction transmitted by a first cloud server paired with the first Internet of Things device, where the device control instruction is an instruction transmitted by the second Internet of Things device to the first cloud server via a second cloud server, and the second cloud server is a cloud server paired with the second Internet of Things device.

Similarly, the first cloud server paired with the first Internet of Things device may be a cloud server of the same Internet of Things system to which the first Internet of Things device belongs.

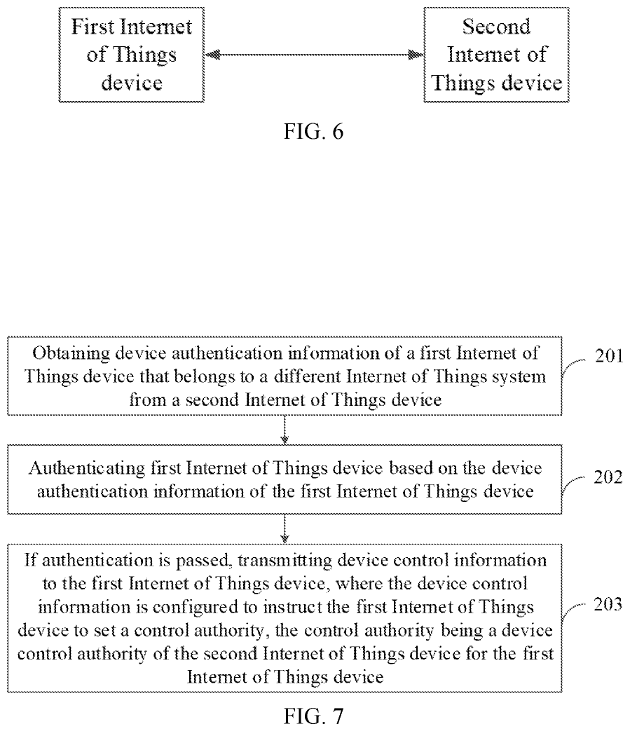

In another alternative embodiment, referring to FIG. 6, the first Internet of Things device may establish a control connection relationship with the second Internet of Things device, so that a device control instruction transmitted by the second Internet of Things device may be received based on the control connection relationship. Specifically, the step of “receiving a device control instruction transmitted by the second Internet of Things device” can include:
establishing a control connection relationship with the second Internet of Things device, wherein the control connection relationship is configured for the second Internet of Things device to perform device control for the first Internet of Things device; and
receiving a device control instruction transmitted by the second Internet of Things device based on the control connection relationship.

It should be noted that the control connection relationship established here is a connection relationship in a control process. Specifically, a process in which the second Internet of Things device performs device control for the first Internet of Things device may include both configuration and control. The control refers to a process in which the second Internet of Things device performs device control for the first Internet of Things device. For example, the second Internet of Things device may control the first Internet of Things device by transmitting a device control instruction to the first Internet of Things device.

In the present application, the control may be directly performed after the configuration is completed. If the connection relationship established in the configuration process is valid, the first Internet of Things device may continue using the connection relationship established in the configuration process, and receive a device control instruction transmitted by the second Internet of Things device based on the connection relationship.

If the connection relationship is invalid, or the second Internet of Things device does not directly control the first Internet of Things device after the configuration is completed, but controls the first Internet of Things device after the configuration is completed and the connection relationship is invalid, the first Internet of Things device may establish a control connection relationship with the second Internet of Things device so that the device control instruction transmitted by the second Internet of Things device may be received based on the control connection relationship.

There are multiple manners in which the first Internet of Things device may establish the control connection relationship with the second Internet of Things device. For example, since the device control information of the second Internet of Things device obtained by the first Internet of Things device may include an object identification of the device control object and connection key information corresponding to the device control object, the control connection relationship with the second Internet of Things device may be established based on the object identification and the connection key information. Specifically, the step of “establishing the control connection relationship with the second Internet of Things device” can include:
establishing a control connection relationship with the second Internet of Things device based on the object identification and the connection key information.

For example, the first Internet of Things device and the second Internet of Things device may perform security negotiation with the objection identification and the connection key information to establish an encrypted connection, so as to establish a control connection relationship between the first Internet of Things device and the second Internet of Things device. It should be noted that the method for establishing the control connection relationship herein may be the same as or different from the method for establishing the connection relationship in the configuration process in the foregoing description, which is not limited in the present application.

In some embodiments, since there may be a plurality of second Internet of Things devices in different Internet of things systems that have set their device control authorities for the first Internet of Things device in consideration of a practical application, and there may be a plurality of second Internet of Things devices requesting to establish the control connection relationship with the first Internet of Things device in the control process and the first Internet of Things device should establish the control connection relationship with the configured second Internet of Things devices, the first Internet of Things device may determine a target second Internet of Things device from the plurality of second Internet of Things devices and establish the control connection relationship with the target second Internet of Things device. Specifically, the device control information of the second Internet of Things device obtained by the first Internet of Things device may further include a system identification of an Internet of Things system to which the second Internet of Things object belongs, i.e., a target system identification of the target Internet of Things system, and a target device identification allocated by the target Internet of Things system for the first Internet of Things device in addition to the object identification of the device control object and the connection key information corresponding to the device control object. Specifically, the step of “establishing a control connection relationship with the second Internet of Things device based on the object identification and the connection key information” can include:
obtaining a control connection request of a second Internet of Things device, wherein the control connection request includes a second system identification, and the second system identification is a device identifier of an Internet of things system to which the second Internet of Things device belongs; and
in response to the second system identification matching the target system identification, establishing a control connection relationship with the second Internet of Things device based on the target device identification, the object identification, and the connection key information.

The control connection request obtained by the first Internet of Things device is data requesting to establish a control connection relationship with the first Internet of Things device. The control connection request may include a second system identification, where the second system identification is a system identification of the Internet of things system to which the second Internet of Things device transmitting the control connection request belongs. Data forms of the control connection request may include a variety of data forms, such as a multicast packet, a broadcast packet.

In the control process, the first Internet of Things device may obtain a plurality of control connection requests, which may be transmitted by the second Internet of Things devices of the different Internet of things systems to the first Internet of Things device. The first Internet of Things device may compare a second system identification corresponding to each of the control connection requests with the target system identification, and if the second system identification matches the target system identification, it may be determined that the second Internet of Things device transmitting the control connection request is the configured second Internet of Things device along with the first Internet of Things device, and the first Internet of Things device may further establish a control connection relationship with the second Internet of Things device based on the target device identification, the object identification, and the connection key information.

As an example, the second Internet of Things device may transmit a multicast or broadcast packet by means of a multicast packet or the like within a local area network, so as to transmit a control connection request to the first Internet of Things device, where the control connection request includes a second system identification being a device identification of an Internet of things system to which the second Internet of Things device belongs, and a format of the packet is agreed in advance. Accordingly, the first Internet of Things device can obtain the control connection request of the second Internet of Things device. If the second system identification matches the target system identification, the first Internet of Things device may further establish a control connection relationship with the second Internet of Things device based on the target device identification, the object identification, and the connection key information. Specifically, the step of “establishing a control connection relationship with the second Internet of Things device based on the target device identification, the object identification, and the connection key information” may include:
generating device connection response information of the control connection request, where the device connection response information comprises the target device identification; and
transmitting the device connection response information to the second Internet of Things device to establish the control connection relationship with the second Internet of Things device based on the object identification and the connection key information.

As an example, after obtaining the control connection request of the second Internet of Things device, the first Internet of Things device may determine the Internet of things system to which the second Internet of Things device transmitting the control connection request belongs based on the second system identification included in the control connection request, and the first Internet of Things device may determine the device ID allocated by the Internet of things system for the first Internet of Things device, and generate device connection response information including the device ID.

Further, the first Internet of Things device may transmit the device connection response information to the second Internet of Things device, so that the second Internet of Things device learns identity of the first Internet of Things device with which the second Internet of Things device establishes a control connection relationship. As such, the first Internet of Things device may further establish the control connection relationship with the second Internet of Things device based on the object identification and the connection key information.

After the connection relationship between the first Internet of Things device and the second Internet of Things device is established, the first Internet of Things device can receive the device control instruction transmitted by the second Internet of Things device based on the control connection relationship. As an example, after the connection relationship between the first Internet of Things device and the second Internet of Things device is established, i.e., a control connection channel for data interaction between the first Internet of Things device and the second Internet of Things device may be established, the first Internet of Things device and the second Internet of Things device may perform data interaction via the control connection channel, for example, transmitting device control instruction and receiving the device control instruction.

In the present application, after receiving the device control instruction transmitted by the second Internet of Things device, the first Internet of Things device may perform an operation corresponding to the device control instruction.

For example, the device control instruction may include a service calling instruction, where the service calling instruction may be used to call a service provided by the first Internet of Things device. Thus, the first Internet of Things device may receive the service calling instruction transmitted by the second Internet of Things device and call a service corresponding to the service calling instruction to implement device control of the second Internet of Things device to the first Internet of Things device.

For another example, the device control instruction may include an information changing instruction, where the information changing instruction may be used to change device control information stored by the first Internet of Things device. For example, the information changing instruction may be used to modify the ACL of the first Internet of Things device, for example, may be used to modify authority information stored in the ACL, and may be used to update connection key information stored in the ACL, or the like. Specifically, the step of “executing an operation corresponding to the device control instruction” can include:
determining a device control object corresponding to the device control instruction; and
in response to the device control object having an information changing authority for the first Internet of Things device, executing an information changing operation corresponding to the information changing instruction.

There may be a plurality of manners in which the first Internet of Things device determines the device control object corresponding to the device control instruction. For example, the first Internet of Things device may receive the device control request transmitted by the second Internet of Things device, where the device control request may include the device control instruction and the object identification of the device control object, so that the first Internet of Things device may determine the device control object corresponding to the device control instruction based on the object identification.

Further, the first Internet of Things device may determine whether the device control object has an information changing authority, for example, by interrogating the device control information stored by the first Internet of Things device, such as, by interrogating the ACL of the first Internet of Things device. Specifically, if the device control object has an information changing authority for the first Internet of Things device, the first Internet of Things device executes an information changing operation corresponding to the information changing instruction.

As an example, the device control object of the second Internet of Things device may be a third party local hub F whose an object attribute is an administrator. That is, the third party local hub F has the information changing authority for the first Internet of Things device. In this example, the third party local hub F may periodically transmit a device control instruction to the first Internet of Things device, where the device control instruction may include an ACL packet and an object identification of the third party local hub F, and the ACL packet is used for the first Internet of Things device to update its ACL.

After receiving the device control instruction, the first Internet of Things device may extract the object identification from the device control instruction, and may interrogate the ACL to know that the device control object corresponding to the device control instruction is the third party local hub F, and the object attribute of the third party local hub F is the administrator. Therefore, the first Internet of Things device may determine that the third party local hub F has the information changing authority for the first Internet of Things device, and in this case, the first Internet of Things device may perform the information changing operation corresponding to the information changing instruction based on the ACL packet, that is, update the ACL.

It can be seen from above according to the embodiments of the present application that the device authentication information of the second Internet of Things device that belongs to the different Internet of Things system from the first Internet of Things device can be obtained; the second Internet of Things device can be authenticated based on the device authentication information of the second Internet of Things device; in response to the authentication being passed, the device control information of the second Internet of Things device can be obtained; and the device control authority of the second Internet of Things device for the first Internet of Things device can be set based on the device control information.

The solution can enable the second Internet of Things device that belongs to the different Internet of Things system than the first Internet of Things device to set the device control authority for the first Internet of Things device, thereby implementing device control in a scenario across the Internet of Things systems. Additionally, the solution can further authenticate the second Internet of Things device while setting the device control authority of the second Internet of Things device for the first Internet of Things device, thereby enhancing the security of device control. In addition, compared with the protocol interconnection or standardization between one cloud and another cloud or between an end and one cloud, the solution avoids the problem that the performance and the stability of the protocol interconnection or standardization between one cloud and another cloud are not high due to the long data link, and improves the problem that the device manufacturer of the protocol interconnection or standardization between an end and one cloud is less motivated and difficult to push because the Internet of Things device cannot access the cloud of the device manufacturer. As such, the solution can support that the Internet of Things devices are controlled by a local hub device such as a third-party application, a smart sound box, a gateway, a smart television, or a router without affecting the Internet of Things devices being connected to the cloud of the device manufacturer at a low cost, so that the interconnection and intercommunication between the Internet of Things devices across the Internet of Things systems are improved.

In accordance with the methods described in the above embodiments, further details are given below by way of example.

The present embodiment will be described from the perspective of a second setting apparatus, which may be specifically integrated in a terminal.

As shown in FIG. 4, a method for setting a device control authority includes steps 201-203 as follows.

At step 201, device authentication information of a first Internet of Things device that belongs to a different Internet of Things system from a second Internet of Things device may be obtained.

The device authentication information is information required for the second Internet of Things device to authenticate the first Internet of Things device. For example, the second Internet of Things device may determine the reliability of the first Internet of Things device by authenticating the first Internet of Things device, so as to ensure security of subsequent device control.

There may be a variety of forms of the device authentication information. For example, the device authentication information may be authorization information determined by negotiation between one Internet of Things system to which the first Internet of Things device belongs (which may be referred to as the first Internet of Things system for purpose of distinguishing) and another Internet of Things system to which the second Internet of Things device belongs (which may be referred to as the second Internet of Things system for purpose of distinguishing), where the authorization information represents mutual authentication between the first Internet of Things system and the second Internet of Things system.

For another example, the device authentication information may be to-be-authenticated information transmitted by the first Internet of Things device. After receiving the to-be-authenticated information, the second Internet of Things device still needs to perform further authentication on the to-be-authenticated information to determine a device authentication result of the first Internet of Things device. As an example, the authentication process may be implemented based on an authentication mechanism of a challenge/response, and the device authentication information obtained by the second Internet of Things device may be a response value Rca1′ generated by the first Internet of Things device based on a challenge value Rc1 transmitted by the second Internet of Things device.

There may be multiple manners in which the second Internet of Things device obtains the device authentication information. For example, a connection relationship between the second Internet of Things device and the first Internet of Things device can be established and the device authentication information can be obtained based on the connection relationship. Specifically, the step of “obtaining device authentication information of a first Internet of Things device that belongs to a different Internet of Things system from a second Internet of Things device” may include:
establishing a connection relationship between the second Internet of Things device and the first Internet of Things device, where the second Internet of Things device and the first Internet of Things device belong to different Internet of Things systems; and
obtaining device authentication information of the first Internet of Things device based on the connection relationship.

In some embodiments, the second Internet of Things device may request the first Internet of Things device to establish a connection relationship between the second Internet of Things device and the first Internet of Things device by transmitting connection interrogation information to the first Internet of Things device. Specifically, the step of “establishing a connection relationship between the second Internet of Things device and the first Internet of Things device” can include:
generating connection interrogation information meeting a preset interrogation format;
transmitting the connection interrogation information to the first Internet of Things device to receive interrogation response information transmitted by the first Internet of Things device based on the connection interrogation information, where the interrogation response information includes device information of the first Internet of Things device; and
establishing a connection relationship between the second Internet of Things device and the first Internet of Things device based on the device information.

As an example, the second Internet of Things device may generate connection interrogation information, which may be specifically in the form of a packet being a pre-agreed preset interrogation format. The second Internet of Things device may transmit a multicast packet or a broadcast packet in the local area network by means of the multicast packet or the like, so as to transmit the connection interrogation information to the first Internet of Things device.

Further, the second Internet of Things device may receive interrogation response information transmitted by the first Internet of Things device based on the connection interrogation information, where the interrogation response information may be specifically in the form of a packet being a pre-agreed interrogation response format, and the interrogation response information includes device information of the first Internet of Things device.

In a practical application, it is considered that the second Internet of Things device may establish a connection relationship with a plurality of first Internet of Things devices and thus control the first Internet of Things devices, that is, the second Internet of Things device may transmit connection interrogation information to the plurality of first Internet of Things devices, and accordingly, the second Internet of Things device may receive interrogation response information returned by the plurality of first Internet of Things devices. Therefore, the second Internet of Things device may determine the identity of respective one of the first Internet of Things devices with which the second Internet of Things device will establish a connection relationship based on the device information in the interrogation response information received by the second Internet of Things device.

After determining the identity of the first Internet of Things device with which the second Internet of Things device will establish a connection relationship, the second Internet of Things device can establish a connection relationship with the first Internet of Things device. There may be a number of ways of establishing the connection relationship between the first Internet of Things device and the second Internet of Things device. For example, the connection relationship can be implemented by exchanging a key, for example, by exchanging a Personal Identification Number (PIN) code. Specifically, the step of “establishing the connection relationship between the second Internet of Things device and the first Internet of Things device based on the device information” can include:
obtaining connection verification information of the first Internet of Things device based on the device information; and
establishing a connection relationship between the second Internet of Things device and the first Internet of Things device based on the connection verification information.

The connection verification information is related information to be verified upon establishing the connection relationship between the second Internet of Things device and the first Internet of Things device in the configuration process. Specifically, if verification of the connection verification information is passed, the connection relationship between the second Internet of Things device and the first Internet of Things device can be further established. Otherwise, the connection relationship between the second Internet of Things device and the first Internet of Things device is not established. For example, the connection verification information may be key information, such as a PIN code.

There may be multiple manners in which the second Internet of Things device may obtain the connection verification information of the first Internet of Things device based on the device information of the first Internet of Things device. For example, the connection verification information may be input by a user. Specifically, the second Internet of Things device may, after obtaining the device information of the first Internet of Things device, prompt the user that the first Internet of Things device is to be networked with the second Internet of Things device and thus require the user to perform out-of-band confirmation by inputting a PIN code or scanning a two-dimensional code, or the like.

In some embodiments, the user may transmit the connection verification information of the first Internet of Things device to the second Internet of Things device after determining the connection verification information of the first Internet of Things device, so that the second Internet of Things device can obtain the connection verification information. There are multiple manners in which the user may determine the connection verification information of the first Internet of Things device. For example, the user may view fixed connection verification information in the device package of the first Internet of Things device. For another example, the user may obtain the connection verification information of the first Internet of Things device via a first Internet of Things APP paired with the first Internet of Things device. For example, the user may obtain the connection verification information generated by the first Internet of Things APP, or interrogate the connection verification information of the first Internet of Things device via the first Internet of Things APP. Alternatively, if the connection verification information is generated by the first Internet of Things APP, the first Internet of Things APP may transmit the connection verification information to the first Internet of Things device via the first cloud server.

In the present embodiment, there may be multiple manners in which the second Internet of Things device obtains the connection verification information of the first Internet of Things device by a user. For example, the user may directly interact at the second Internet of Things device to transmit the connection verification information of the first Internet of Things device to the second Internet of Things device. Specifically, the step of “obtaining the connection verification information of the first Internet of Things device” may include:
obtaining connection verification information of the first Internet of Things device responsive to an information inputting operation for the second Internet of Things device.

An information input operation for the second Internet of Things device may be a specific touch operation, such as a long-press operation, a double-click operation, a slide operation, or the like. The information input operation for the second Internet of Things device may further be a non-touch operation, such as a voice trigger operation, an image detection trigger operation, a program trigger operation, or the like. Alternatively, the information input operation for the second Internet of Things device may be a combination of a series of operations, which is not limited in the present embodiment.

For example, the second Internet of Things device may include a physical control through which a user may perform an information input operation to input connection verification information of the first Internet of Things device; for another example, the second Internet of Things device may include a display screen on which a user may input connection verification information of a first Internet of Things device by performing a touch operation or scanning a code; for another example, the second Internet of Things device may include a voice interaction module, and the user may perform an information input operation for the second Internet of Things device by performing voice interaction with the second Internet of Things device, thereby inputting connection verification information of the first Internet of Things device; for another example, the second Internet of Things device may include an image recognition module, and the user may transmit an image including the connection verification information to the second Internet of Things device so that the second Internet of Things device may recognize the connection verification information of the first Internet of Things device through the image recognition module; for another example, the user may transmit the connection verification information of the first Internet of Things device to the second Internet of Things device through a near field communication technology; and so on.

In another embodiment, the user may further transmit the connection verification information of the first Internet of Things device to the second Internet of Things device. Specifically, the step of “obtaining the connection verification information of the first Internet of Things device” may include:
obtaining connection verification information transmitted by a target client, where the target client is a client matching the second Internet of Things device, and the connection verification information is connection verification information corresponding to the first Internet of Things device.

As an example, the target client may be a second Internet of Things app, and the user may, after determining the connection verification information of the first Internet of Things device, input the connection verification information into the second Internet of Things app, and transmit the connection verification information to the second Internet of Things device via the second Internet of Things app, so that the second Internet of Things device may obtain the connection verification information of the first Internet of Things device.

In the present application, after the connection relationship between the second Internet of Things device and the first Internet of Things device is established, the device authentication information of the first Internet of Things device can be further obtained based on the connection relationship. For example, the authentication process may be implemented based on an authentication mechanism of a challenge/response. Specifically, the step of “obtaining device authentication information of the first Internet of Things device” can include:
determining first authentication challenge information for the first Internet of Things device, where the first authentication challenge information is authentication challenge information of the second Internet of Things device for the first Internet of Things device;
transmitting the first authentication challenge information to the first Internet of Things device; and
obtaining device authentication information generated by the first Internet of things device based on the first authentication challenge information.

As an example, the authentication challenge information of the second Internet of Things device for the first Internet of Things device, i.e., the first authentication challenge information can be represented as Rc1, and the device authentication information generated by the first Internet of Things device based on the first authentication challenge information may be represented as Rca1′.

There may be multiple manners in which the second Internet of Things device may determine the first authentication challenge information. For example, the first authentication challenge information may be generated by the second Internet of Things device. For example, a random number is generated by the second Internet of Things device and used as the first authentication challenge information.

For another example, the first authentication challenge information may be generated by the second authentication server. For example, a random number is generated by the second authentication server and used as the first authentication challenge information, and the first authentication challenge information is transmitted to the second Internet of Things device. Specifically, the step of “determining first authentication challenge information for the first Internet of Things device” may include:
receiving first authentication challenge information transmitted by a second authentication server, where the second authentication server is an authentication server paired with the second Internet of Things device.

As an example, referring to FIG. 3, the first Internet of Things device may be an IOT device shown by 1001, and the second Internet of Things device may be a third party local hub shown by 1003, and the second authentication server may be a third party authentication center shown by 1004. The third party authentication center may generate a random number Rc1 to initiate challenge authentication to the IoT device. The third party authentication center may transmit Rc1 to the third party local center, so that the third party local center may determine the authentication challenge information for the IoT device after receiving Rc1 transmitted by the third party authentication center. Further, the third party local hub may transmit Rc1 to the IoT device, and after the IoT device receives Rc1, the IoT device may generate a challenge response Rca1′ of Rc1 and return Rca1′ to the third party local hub.

In the present application, after the connection relationship between the second Internet of Things device and the first Internet of Things device is established in the present application, the connection relationship may be configured for the second Internet of Things device to authenticate the first Internet of Things device and for the first Internet of Things device to authenticate the second Internet of Things device. For example, the authentication process may be implemented based on an authentication mechanism of a challenge/response. Specifically, after the step of “establishing a connection relationship between the second Internet of Things device and the first Internet of Things device”, the apparatus for setting the device control authority can further include:
obtaining second authentication challenge information for the second Internet of Things device, where the second authentication challenge information is authentication challenge information of the first Internet of Things device for the second Internet of Things device;
generating device authentication information corresponding to the second Internet of Things device based on the second authentication challenge information, where the device authentication information is used for the first Internet of Things device to authenticate the second Internet of Things device; and
transmitting device authentication information corresponding to the second Internet of Things device to the first Internet of Things device to enable the first Internet of Things device to authenticate the second Internet of Things device based on the device authentication information corresponding to the second Internet of Things device.

There may be multiple manners in which the second Internet of Things device may obtain the second authentication challenge information. For example, after the connection relationship between the second Internet of Things device and the first Internet of Things device is established, i.e., a connection channel for data interaction between the second Internet of Things device and the first Internet of Things device may be established, the first Internet of Things device may transmit second authentication challenge information to the second Internet of Things device through the connection channel. Correspondingly, the second Internet of Things device may obtain the second authentication challenge information through the connection channel.

As an example, the authentication challenge information of the first Internet of Things device for the second Internet of Things device, i.e., the first authentication challenge information, can be represented as Rc.

The device authentication information generated by the second Internet of Things device based on the second authentication challenge information is used as a response of authentication challenge initiated by the second Internet of Things device to the first Internet of Things device. Specifically, the device authentication information may be used for the first Internet of Things device to authenticate the second Internet of Things device.

There are multiple manners in which the second Internet of Things device may generate device authentication information corresponding to the second Internet of Things device based on the second authentication challenge information. For example, the device authentication information may be implemented by using a first authentication server and a second authentication server, where the first authentication server is an authentication server paired with the first Internet of Things device, the second authentication server is an authentication server paired with the second Internet of Things device, and the first authentication server and the second authentication server are mutually authenticated servers. Specifically, the step of “generating device authentication information corresponding to the second Internet of Things device based on the second authentication challenge information” may include:
transmitting second authentication challenge information to a second authentication server, where the second authentication server is an authentication server paired with the second Internet of Things device;
receiving device authentication information transmitted by the second authentication server, where the device authentication information is generated by a first authentication server based on the second authentication challenge information, the first authentication server is an authentication server paired with the first Internet of Things device, and the first authentication server and the second authentication server are mutual authentication servers.

As an example, referring to FIG. 3, the first Internet of Things device may be an IOT device shown by 1001, and the second Internet of Things device may be a third party local hub shown by 1003, the second authentication server may be a third party authentication center shown by 1004, and the first authentication server may be a device cloud authentication center shown by 1002. The IoT device may initiate an authentication challenge to the third party local hub with a challenge value of Rc. The third party local hub may transmit Rc to the third party authentication center, which may request a challenge response of Rc from the device cloud authentication center after receiving Rc. It should be noted that the third party authentication center and the device cloud authentication center are mutually authenticated with each other. For example, the third party authentication center and the device cloud authentication center are authenticated by the TSL bidirectional certificates. In this way, the device cloud authentication center can confirm the validity of the third party authentication center. The device cloud authentication center may return a challenge response Rca of Rc to the third party authentication center, and further, the third party authentication center may return Rca to the third party local hub. After receiving Rca, the third party local hub may transmit Rca to the IoT device, so that the IoT device may authenticate the third party local hub based on Rca.

At step 202, the first Internet of Things device may be authenticated based on the device authentication information of the first Internet of Things device.

There may be multiple manner in which that the second Internet of Things device may authenticate the first Internet of Things device based on the device authentication information of the first Internet of Things device. For example, the first Internet of Things device may be authenticated by verifying the device authentication information and determining the authentication result of the first Internet of Things device based on the verification result. Specifically, there may be multiple verification manners, for example, which may include comparing the device authentication information, calculating the device authentication information, querying and matching the device authentication information, and the like.

In some embodiments, the second Internet of Things device may be authenticated by verifying the device authentication information and determining the authentication result of the first Internet of Things device based on the verification result. Specifically, the step of “authenticating the first Internet of Things device based on the device authentication information of the first Internet of Things device” may include:
determining authentication verification information required for verifying the device authentication information; and
verifying the device authentication information based on the authentication verification information to authenticate the first Internet of Things device.

The authentication verification information is related information required for verifying the device authentication information and may be in multiple data forms. For example, the authentication verification information may be a character string, a value, or a collection and the like.

In the present application, the authentication verification information required for verifying the device authentication information may be determined according to a manner of verifying the device authentication information.

In some embodiments, verification of the device authentication information may be implemented by calculating the device authentication information. Therefore, the authentication verification information required for verifying the device authentication information may be preset value information, such as a preset value or a value range. As an example, the authentication verification information may be a preset value range, and the second Internet of Things device may calculate the device authentication information of the first Internet of Things device, and compare the calculation result with the preset value range to verify the device authentication information. Specifically, if the calculation result falls within the preset value range, the second Internet of Things device may determine that the authentication result of the first Internet of Things device is that the authentication is passed, that is, it is determined that the first Internet of Things device is trusted. Otherwise, it is determined that the authentication result of the first Internet of Things device is that the authentication fails.

In another embodiment, verification of the device authentication information may be implemented by querying and matching the device authentication information. Therefore, the authentication verification information required for verifying the device authentication information may be a preset information set, and at least one information element may be included in the set. For example, the set may include at least one piece of device verification information authenticated by the second Internet of Things device. Verification of the device authentication information may be implemented by querying whether there is an information element matching the device authentication information in the information set. Specifically, if there is an information element matching the device authentication information in the information set, the second Internet of Things device may determine that the authentication result of the first Internet of Things device is that the authentication is passed, that is, it is determined that the first Internet of Things device is trusted. Otherwise, it is determined that the authentication result of the first Internet of Things device is that the authentication fails.

In another embodiment, a process in which the second Internet of Things device performs device authentication on the first Internet of Things device may be implemented based on an authentication mechanism of challenge/response, and a manner in which the second Internet of Things device verifies device authentication information of the first Internet of Things device may be implemented by information comparison. As an example, if the first authentication challenge information of the second Internet of Things device for the first Internet of Things device may be Rc1, and the device authentication information generated by the first Internet of Things device based on the first authentication challenge information may be Rca1, then the authentication verification information required for the second Internet of Things device to verify Rca1 may be Rca1′ calculated by the second Internet of Things device based on Rc1. Further, the second Internet of Things device can compare Rca1′ with Rca1 to verify Rca1. Specifically, if the comparison result is consistent, the second Internet of Things device can determine that the authentication result of the first Internet of Things device is that the authentication is passed, that is, it is determined that the first Internet of Things device is trusted. Otherwise, it is determined that the authentication result of the first Internet of Things device is that the authentication fails.

In the present embodiment, there are multiple manners of determining authentication verification information required for verifying the device authentication information of the first Internet of Things device. For example, the authentication verification information may be implemented by using a first authentication server and a second authentication server, where the first authentication server is an authentication server paired with the first Internet of Things device, the second authentication server is an authentication server paired with the second Internet of Things device, and the first authentication server and the second authentication server are mutually authenticated servers. Specifically, the step of “determining authentication verification information required for verifying the device authentication information” may include:
receiving authentication verification information transmitted by a second authentication server, where the authentication verification information is generated by a first authentication server based on first authentication challenge information, the first authentication server is a server paired with the first Internet of Things device, the second authentication server is a server paired with the second Internet of Things device, the first authentication server and the second authentication server are mutual authentication servers, and the first authentication challenge information is authentication challenge information of the second Internet of Things device for the first Internet of Things device.

As an example, referring to FIG. 3, the first Internet of Things device may be an IOT device shown by 1001, and the second Internet of Things device may be a third party local hub shown by 1003, the second authentication server may be a third party authentication center shown by 1004, and the first authentication server may be a device cloud authentication center shown by 1002. The third party authentication center may generate a random number Rc1 to prepare to initiate challenge to the IoT device. Further, the third party authentication center can request a challenge response of Rc1 to the device cloud authentication center. It should be noted that the third party authentication center and the device cloud authentication center are mutually authenticated with each other. For example, the third party authentication center and the device cloud authentication center are authenticated by the TSL bidirectional certificates. In this way, the device cloud authentication center can confirm the validity of the third party authentication center. The device cloud authentication center may return a challenge response Rca1 of Rc1 to the third party authentication center, and further, the third party authentication center may return Rca1 to the third party local hub. In this way, the third party local hub determines Rca1 required for verifying Rca1′.

At step 203, in response to the authentication being passed, device control information may be transmitted to the first Internet of Things device, where the device control information is configured to instruct the first Internet of Things device to set a control authority, the control authority being a device control authority of the second Internet of Things device for the first Internet of Things device.

Since it is considered that the second Internet of Things device needs to learn the device capability of the first Internet of Things device before further generating the device control information, the device capability information of the first Internet of Things device may be determined before the second Internet of Things device transmits the device control information to the first Internet of Things device, so that the second Internet of Things device may further generate the device control information for the first Internet of Things device. Specifically, before the step of “the transmitting of the device control information to the first Internet of Things device”, the apparatus for setting the device control authority can further include:
determining device capability information of the first Internet of Things device; and
generating device control information for the first Internet of Things device based on the device capability information.

There may be multiple manners in which the second Internet of Things device determines device capability information of the first Internet of Things device. For example, the device capability information can be determined by requesting device capability information of the first Internet of Things device to the first Internet of Things device. Specifically, the step of “determining the device capability information of the first Internet of Things device” may include:
generating a device capability request for the first Internet of Things device to transmit the device capability request to the first Internet of Things device; and
receiving device capability information returned by the first Internet of Things device based on the device capability request.

In order to ensure the security of the data interaction, the second Internet of Things device and the first Internet of Things device may make an agreement on a format of the device capability request, so that the second Internet of Things device may request to obtain a capability model of the first Internet of Things device by generating a device capability request meeting a preset agreement format and transmitting the device capability request to the first Internet of Things device.

As an example, referring to FIG. 3, the second Internet of Things device may be a third party local hub shown by 1003, and the first Internet of Things device may be an IoT device shown by 1001, where the third party local hub may generate a device capability request for the IoT device in a pre-agreed format and transmit the device capability request to the IoT device. Further, the third party local hub may receive device capability information returned by the IoT device based on the device capability request, where the device capability information may specifically include a specific model, a type, a controllable instruction, an attribute, a service, and the like of the IoT device.

After determining the device capability information of the first Internet of Things device, the second Internet of Things device can generate device control information for the first Internet of Things device based on the device capability information.

There may be multiple manners of generating the device control information for the first Internet of Things device based on the device capability information. For example, the device control information of the second Internet of Things device to the first Internet of Things device may be generated based on the device capability information for the first Internet of Things device, where the device control information is the device control information bound to the second Internet of Things device, for example, the device control information bound to the device identification of the second Internet of Things device. In this case, the device control information of the second Internet of Things device to the first Internet of Things device may also remain unchanged even if the device control object for performing device control of the first Internet of Things device via the second Internet of Things device is changed.

For another example, in a practical application, considering that the second Internet of Things device can be used as a physical medium via which different device control objects controls the first Internet of Things device, and the different device control objects have different device control requirements for the first Internet of Things device, it is possible to generate device control information corresponding to each of different device control objects for the second Internet of Things device based on the device capability information of the first Internet of Things device in the Internet of things system to which the second Internet of Things device belongs. Specifically, the step of “generating device control information for the first Internet of Things device based on the device capability information” may include:
determining a device control object of the second Internet of Things device, where the device control object is an object that controls the first Internet of Things device via the second Internet of Things device; and
generating device control information of the device control object in a target Internet of Things system to the first Internet of Things device based on the device capability information, where the target Internet of Things system is an Internet of Things system to which the second Internet of Things device belongs.

There may be multiple manners of determining the device control object for the second Internet of Things device. For example, the device control object for the second Internet of Things device may be determined by interacting the second Internet of Things system with the Internet of Things system to which the second Internet of Things device belongs, i.e., the target Internet of Things system; for another example, the device control object for the second Internet of Things device may be determined by interacting the user with the second Internet of Things system; for another example, the device control object for the second Internet of Things device may be determined by the second Internet of Things device based on current device data of the second Internet of Things device; and so on.

In a practical application, the second Internet of Things device may allocate different object identification to different device control objects in the target Internet of Things system. For example, the third party local hub may allocate different subject IDs to different controllers, users, etc., within its own ecology.

After the device control object of the second Internet of Things device is determined, the device control information of the device control object in the target Internet of Things system to the first Internet of Things device can be further generated based on the device capability information.

For example, the second Internet of Things device may determine, based on the device capability information of the first Internet of Things device, a service accessible to the first Internet of Things device and an authority for the accessible service in services provided by the second Internet of Things device to determine the service accessing information of the device control object. Further, the device control information of the device control object in the target Internet of Things system to the first Internet of Things device can be further generated based on the service accessing information of the device control object. Specifically, the step of “generating device control information of the device control object in a target Internet of Things system to the first Internet of Things device based on the device capability information” may include:
determining a service provided by the first Internet of Things device based on the device capability information;
determining service accessing information of the device control object for the service; and
generating device control information of the device control object in the target Internet of Things system to the first Internet of Things device based on the service accessing information.

The device capability information of the first Internet of Things device is related information describing the device capability that can be provided by the first Internet of Things device. For example, the device capability information may include a specific model, a type, a controllable instruction, an attribute, a service, and the like of the device. Therefore, a service provided by the first Internet of Things device can be determined based on the device capability information. As an example, device capability information of the intelligent air conditioner can be used to determine services provided by intelligent air conditioner, including a refrigeration service, a heating service, a dehumidification service, a self-cleaning service, and the like.

There may be multiple manners of determining the service accessing information of the device control object. For example, the service accessing information of the device control object may be determined by interacting the second Internet of Things system with the Internet of Things system to which the second Internet of Things device belongs, i.e., the target Internet of Things system; for another example, the service accessing information of the device control object may be determined by interacting the user with the second Internet of Things system; for another example, the service accessing information of the device control object may be determined by the second Internet of Things device based on current device data of the second Internet of Things device; and so on.

The second Internet of Things device may add the system identification of the target Internet of Things system, the object identification of the device control object, and the service accessing information of the device control object into the device control information of the second Internet of Things device to generate the device control information of the device control object in the target Internet of Things system to the first Internet of Things device. In this case, after obtaining the device control information, the first Internet of Things device can correspondingly set the device control authority of the device control object in the target Internet of Things system for the first Internet of Things device based on the system identification and the object identification.

For example, the third party local hub may add an ecological identification code of the third party local hub, the object identification of the device control object, and the service accessing information into the device control information of the third party local hub to generate the device control information of the device control object in the ecology in which the third party local hub is located to the IoT device, where the service accessing information may include an accessible service and an authority for the service. In this case, after obtaining the device control information, the IoT device may set the device control authority of the device control object in the ecology for the IoT device based on the ecological identification code and the subject ID.

In a practical application, it is considered that the device control object may have an information changing authority for the first Internet of Things device in addition to the service calling authority for the first Internet of Things device. Accordingly, the second Internet of Things device may correspondingly set the information into the device control information, for example, may set the information by the object attribute information of the device control object. In this way, the second Internet of Things device can set the object attribute of the device control object so that the first Internet of Things device learns whether the device control object has the information changing authority. Specifically, the step of “generating device control information of the device control object in the target Internet of Things system to the first Internet of Things device” can include:
determining object attribute information of the device control object; and
generating device control information of the device control object in the target Internet of Things system to the first Internet of Things based on the object attribute information.

Similarly, there may be multiple manners of determining the object attribute information of the device control object. For example, the object attribute information of the device control object may be determined by interacting the second Internet of Things system with the Internet of Things system to which the second Internet of Things device belongs, i.e., the target Internet of Things system; for another example, the object attribute information of the device control object may be determined by interacting the user with the second Internet of Things system; for another example, the object attribute information of the device control object may be determined by the second Internet of Things device based on current device data of the second Internet of Things device; and so on.

As an example, the second Internet of Things device further adds object attribute information of the device control object into the device control information of the second Internet of Things device to generate device control information of the device control object in the target Internet of Things system to the first Internet of Things device. In this case, after obtaining the device control information, the first Internet of Things device may determine whether the device control object has an information changing authority for the first Internet of Things device based on the object attribute information.

For example, the third party local hub may further add role information of the device control object into the device control information of the third party local hub to generate the device control information of the device control object in the ecology in which the third party local hub is located to the IoT device. In this case, after obtaining the device control information, the IoT device may determine whether the device control object has an information changing authority for the IoT device based on the object attribute information.

In a practical application, the device control information generated by the second Internet of Things device may further include information such as a device ID, a connection key, and a key expiration time of the connection key, in addition to a system identification of a second Internet of Things system, a subject ID of the device control object, object attribute information, and service accessing information.

In the present application, after generating the device control information for the first Internet of Things device, the second Internet of Things device may transmit the device control information to the first Internet of Things device. There may be multiple manners in which the second Internet of Things device may transmit the device control information to the first Internet of Things device. For example, the second Internet of Things device may generate a device control packet, where the device control packet may carry the device control information. In this case, the second Internet of Things device may transmit the device control information to the first Internet of Things device by transmitting the device control packet to the first Internet of Things device. Specifically, the step of “transmitting the device control information to the first Internet of Things device” may include:
generating a device control packet, where the device control packet includes device control information of the second Internet of Things device for the first Internet of Things device; and
transmitting device control packet to the first Internet of Things device.

In some embodiments, the second Internet of things device may transmit a device control packet to the first Internet of things device in a predetermined format, where the device control packet may include device control information of the second Internet of things device. Correspondingly, the first Internet of Things device may receive a device control packet transmitted by the second Internet of Things device, and extract the device control information of the second Internet of Things device from the device control packet. For example, the third party local hub may transmit a device control packet to the IoT device in a predetermined format to request the IoT device to set the ACL. Correspondingly, after receiving the device control packet, the IoT device can extract device control information from the device control packet, and set the ACL based on the device control information.

As an example, the second Internet of Things device may transmit the device control packet to the first Internet of Things device through the connection relationship established in the configuration process. Specifically, after the connection relationship between the second Internet of Things device and the first Internet of Things device is established, i.e., a connection channel for data interaction between the second Internet of Things device and the first Internet of Things device may be established, the second Internet of Things device and the first Internet of Things device may perform data interaction via the connection channel, for example, transmitting device control packet and receiving the device control packet.

In the embodiment, the process of setting the device control authority is described above from the perspective of the second Internet of Things device. In a practical application, the device control may be further performed on the basis of the foregoing process. Specifically, the method for setting the device control authority may further include:
transmitting a device control instruction to the first Internet of Things to perform device control for the first Internet of Things via the device control instruction.

In the present application, there may be a plurality of manners in which the second Internet of Things device can transmit a device control instruction to the first Internet of Things device. For example, the step of “transmitting the device control instruction to the first Internet of Things device” can include:
transmitting a device control instruction to a second cloud server to transmit the device control instruction to the first Internet of Things device via the second cloud server, where the second cloud server is a cloud server paired with the second Internet of Things device.

For another example, the step of “transmitting the device control instruction to the first Internet of Things device” may include:
transmitting a device control instruction to a second cloud server to transmit the device control instruction to a first cloud server via the second cloud server and transmit the device control instruction to the first Internet of Things via the first cloud server, where the second cloud server is a cloud server paired with the second Internet of Things, and the first cloud server is a cloud server paired with the first Internet of Things.

For another example, referring to FIG. 6, the second Internet of Things device may establish a control connection relationship with the first Internet of Things device, so that a device control instruction may be transmitted to the first Internet of Things device based on the control connection relationship. Specifically, the step of “transmitting a device control instruction to the first Internet of Things device” can include:
establishing a control connection relationship with the first Internet of Things device, where the control connection relationship is configured for the second Internet of Things device to perform device control for the first Internet of Things device; and
transmitting a device control instruction to the first Internet of Things device based on the control connection relationship.

There are multiple manners in which the second Internet of Things device may establish the control connection relationship with the first Internet of Things device. For example, since the device control information transmitted by the second Internet of Things device to the first Internet of Things device may include an object identification of the device control object and connection key information corresponding to the device control object, the control connection relationship with the first Internet of Things device may be established based on the object identification and the connection key information. Specifically, the step of “establishing the control connection relationship with the first Internet of Things device” can include:
establishing a connection relationship with the first Internet of Things device based on the object identification and the connection key information.

For example, the second Internet of Things device and the first Internet of Things device may perform security negotiation with the objection identification and the connection key information to establish an encrypted connection, so as to establish a control connection relationship between the second Internet of Things device and the first Internet of Things device. It should be noted that the method for establishing the control connection relationship herein may be the same as or different from the method for establishing the connection relationship in the configuration process in the foregoing description, which is not limited in the present application.

In some embodiments, since it is considered in a practical application that the second Internet of Things device may have set its device control authorities for a plurality of first Internet of Things devices across different Internet of Things systems, and the second Internet of Things device may request to establish a control connection relationship with each of the plurality of first Internet of Things devices and correspondingly receive control connection response information returned by the first Internet of Things device in the process of control, where the control connection response information may include a first device identification corresponding to the first Internet of Things device. Therefore, when the second Internet of Things device wants to establish a control connection relationship between the second Internet of Things device and the target first Internet of Things device, the second Internet of Things device may determine whether the first Internet of Things device transmitting the control connection response information is a target first Internet of Things device by comparing the target device identification of the target first Internet of Things device with the first device identification in the control connection response information, so that the control connection relationship between the second Internet of Things device and the target first Internet of Things device can be further established. Specifically, the device control information of the second Internet of Things device transmitted to the first Internet of Things device may further include a system identification of an Internet of Things system to which the second Internet of Things object belongs, i.e., a target system identification of the target Internet of Things system, and a target device identification allocated by the target Internet of Things system for the first Internet of Things device in addition to the object identification of the device control object and the connection key information corresponding to the device control object. Specifically, the step of “establishing a connection relationship with the first Internet of Things device based on the object identification and the connection key information” can include:
generating a control connection request to transmit the control connection request to the first Internet of Things device, where the control connection request comprises the target system identification;
receiving control connection response information transmitted by the first Internet of Things device, where the control connection response information comprises a first device identification corresponding to the first Internet of Things device; and
in response to the first device identification matching the target device identification, establishing a control connection relationship with the first Internet of Things device based on the object identification and the connection key information.

The control connection request generated by the second Internet of Things device is configured to request the second Internet of Things device to establish a control connection relationship with the first Internet of Things device. The control connection request may include a target system identification, where the target system identification is the system identification of the Internet of Things system to which the second Internet of Things device generating the control connection request belongs. Data forms of the control connection request may include a variety of data forms, such as a multicast packet, a broadcast packet.

In the process of controlling the first Internet of Things device via the second Internet of Things device, the second Internet of Things device may generate and transmit a control connection request to the first Internet of Things device. Therefore, the second Internet of Things device may transmit a control connection request to a plurality of first Internet of Things device, and correspondingly, the second Internet of Things device may receive control connection response information from different first Internet of Things device, where the control connection response information includes a first device identification corresponding to the first Internet of Things device. The second Internet of Things device may compare the first device identification corresponding to each piece of control connection response information with the target device identification. If the first device identification and the target device identification match each other, it may be determined that the first Internet of Things device transmitting the control connection response information is the first Internet of Things device with which the second Internet of Things device wants to establish a control connection relationship. The second Internet of Things device can further establish a control connection relationship with the first Internet of Things device based on the object identification and the connection key information.

As an example, the second Internet of Things device may transmit a multicast or broadcast packet by means of a multicast packet or the like within a local area network, so as to transmit a control connection request to the first Internet of Things device, where the control connection request includes a target system identification being a device identification of an Internet of things system to which the second Internet of Things device belongs, and a format of the packet is agreed in advance. Accordingly, the first Internet of Things device can obtain the control connection request and return control connection response information including the first device identification corresponding to the first Internet of Things device to the second Internet of Things device. The second Internet of Things device may compare the first device identification with the target device identification, and if the first device identification and the target device identification are matched with each other, the second Internet of Things device may further establish a control connection relationship with the first Internet of Things device based on the object identification and the connection key information.

After the control connection relationship between the second Internet of Things device and the first Internet of Things device is established, the second Internet of Things device can transmit the device control instruction to the first Internet of Things device based on the control connection relationship. Specifically, after the connection relationship between the second Internet of Things device and the first Internet of Things device is established, i.e., a connection channel for data interaction between the second Internet of Things device and the first Internet of Things device may be established, the second Internet of Things device and the first Internet of Things device may perform data interaction via the connection channel, for example, transmitting device control packet and receiving the device control packet.

In the present application, after receiving the device control instruction transmitted by the second Internet of Things device, the first Internet of Things device may perform an operation corresponding to the device control instruction.

For example, the device control instruction may include a service calling instruction, where the service calling instruction may be used to call a service provided by the first Internet of Things device. Thus, the second Internet of Things device may transmit the service calling instruction to the first Internet of Things device and call a service corresponding to the service calling instruction to implement device control of the second Internet of Things device to the first Internet of Things device.

For another example, the device control instruction may include an information changing instruction, where the information changing instruction may be used to change device control information stored by the first Internet of Things device. For example, the information changing instruction may be used to modify the ACL of the first Internet of Things device, for example, may be used to modify authority information stored in the ACL, and may be used to update connection key information stored in the ACL, or the like. Specifically, the step of “transmitting the device control instruction to the first Internet of Things device” may include:
determine a device control object of the first Internet of Things device;
in response to the device control object having an information changing authority for the first Internet of Things device, generating a device control instruction based on the information changing authority; and
transmitting the device control instruction to the first Internet of Things device.

There may be multiple manners in which the second Internet of Things device determines the device control object for the first Internet of Things device. For example, the device control object for the first Internet of Things device may be determined by interacting the second Internet of Things system with the Internet of Things system to which the second Internet of Things device belongs, i.e., the target Internet of Things system; for another example, the device control object for the first Internet of Things device may be determined by interacting the user with the second Internet of Things system; for another example, the device control object for the first Internet of Things device may be determined by the second Internet of Things device based on current device data of the second Internet of Things device; and so on.

Further, the second Internet of Things device may determine whether the device control object has an information changing authority, for example, based on an object attribute of the device control object. Specifically, if the device control object has an information changing authority for the first Internet of Things device, then the second Internet of Things device can generate a device control instruction based on the information changing authority, for example, an information changing instruction, and transmit the device control instruction to the first Internet of Things device, so the second Internet of Things device can change the device control information stored in the first Internet of Things device with the device control instruction.

As an example, the device control object of the second Internet of Things device may be a third party local hub F whose an object attribute is an administrator. That is, the third party local hub F has the information changing authority for the first Internet of Things device. In this example, the third party local hub F may periodically generate and transmit a device control instruction to the first Internet of Things device, where the device control instruction may include an ACL packet and an object identification of the third party local hub F, the object identification is used for the first Internet of Things device to determine that the third party local hub has an information changing authority, and the ACL packet is used for the first Internet of Things device to update its ACL.

In the embodiments of the present application, the description of each of the embodiments has its own emphasis. For a part not described in detail in the explanation of a certain step or a certain term in a certain embodiment, reference may be made to the above detailed description of the method for setting the device control authority, which is not repeatedly described herein.

As can be seen from above that the embodiments of the present application can enable the second Internet of Things device to set the device control authority of the second Internet of Things device for the first Internet of Things device, where the second Internet of Things device and the first Internet of Things device belong to different Internet of Things systems, thereby implementing device control in a scenario across the Internet of Things systems. Additionally, the embodiments of the present can further authenticate the first Internet of Things device while setting the device control authority of the second Internet of Things device for the first Internet of Things device, thereby enhancing the security of device control. In addition, compared with the protocol interconnection or standardization between one cloud and another cloud or between an end and one cloud, the solution avoids the problem that the performance and the stability of the protocol interconnection or standardization between one cloud and another cloud are not high due to the long data link, and improves the problem that the device manufacturer of the protocol interconnection or standardization between an end and one cloud is less motivated and difficult to push because the Internet of Things device cannot access the cloud of the device manufacturer. As such, the solution can support that the Internet of Things devices are controlled by a local hub device such as a third-party application, a smart sound box, a gateway, a smart television, or a router without affecting the Internet of Things devices being connected to the cloud of the device manufacturer at a low cost, so that the interconnection and intercommunication between the Internet of Things devices across the Internet of Things systems are improved.

In accordance with the methods described in the above embodiments, further details are given below by way of example.

In the present embodiment, the first setting device is specifically integrated in one terminal, for example, a first Internet of Things device, and the second setting device is specifically integrated in another terminal. For example, the first Internet of Things device and the second Internet of Things device are taken as an example for illustration.

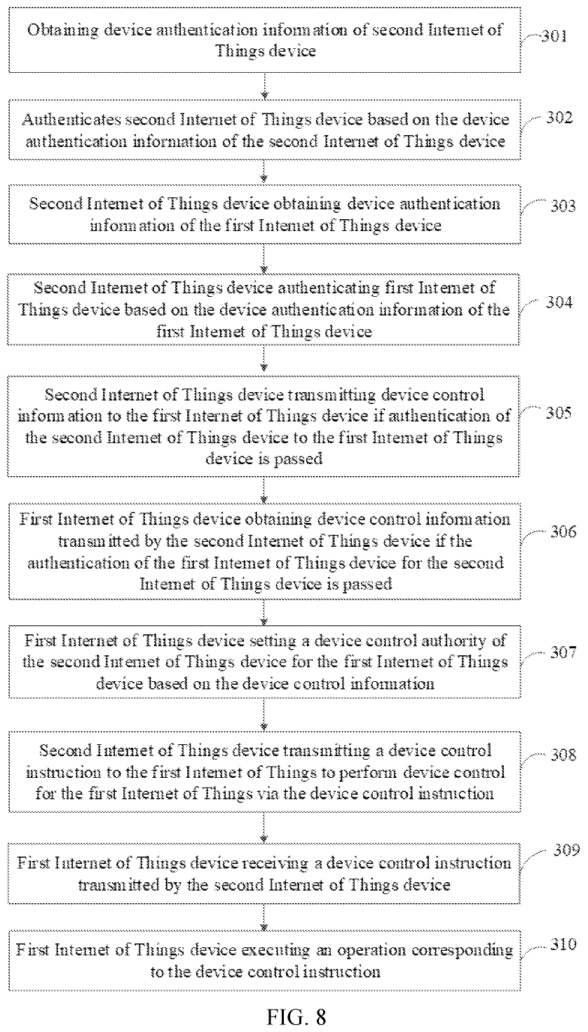

As shown in FIG. 8, a method for setting a device control authority includes steps 301-3010 as follows.

At step 301, a first Internet of Things device obtains device authentication information of a second Internet of Things device, where the first Internet of Things device and the second Internet of Things device belong to different Internet of Things systems.

In some embodiments, the first Internet of Things device may be an IOT device shown by 1001 of FIG. 3, and the second Internet of Things device may be a third party local hub shown by 1003 of FIG. 3.

In the present embodiments, a connection relationship between the IoT device and the third party local hub may be established before mutual authentication of the IoT device with the third party local hub. Specifically, after entering the network distribution state, the IoT device may enter a mode of a pre-agreed listening port, so as to listen for a broadcast packet in a local area network. However, in the local area network, the third party local hub (serving as a configurator at this time) may transmit a multicast packet or a broadcast packet by means of a multicast packet or the like, where the packet format is pre-agreed.

After receiving the broadcast packet, the IoT device may unicast a response packet to the third party local hub, where the response packet may carry device information of the IoT device, and the format of the response packet is pre-agreed. After receiving the device information of the IoT device, the third party local center may prompt the user to present device network distribution, and request the user to perform out-of-band confirmation by inputting a PIN code, scanning a two-dimensional code, and the like.

There are multiple manners in which the user may determine the PIN code. For example, the user may generate a disposable PIN code on the IoT app corresponding to the IoT device shown by 1005 of FIG. 3 or view a fixed PIN code directly in the IoT device package. Specifically, if the PIN code is generated by the IoT app, the IoT app may pass the PIN code to the IoT device through the IoT cloud shown by 1006 of FIG. 3.

There may be multiple manners in which the user may input the PIN code into the third party local hub. For example, the user may input the PIN code on the third party local hub, or may input the PIN code on the app corresponding to the third party local hub to transmit data to the third party local hub through the app.

As such, the IoT device and the third party local hub may perform secure negotiation through a known PIN code to establish an encrypted connection, for example, by means of DTLS+PSK or PIN+ECDH. It should be noted that establishment of the encrypted connection may be performed by the third party local hub or may be performed by the app corresponding to the third party local hub.

After the connection relationship between the IoT device and the third party local hub is established, authentication between the IoT device and the third party local hub can be implemented based on the connection relationship. For purpose of distinguishing the connection relationship, the connection relationship established herein may be referred to as a configuration connection relationship.

In some embodiments, the IoT device may initiate an authentication challenge to the third party local hub where a challenge value of the authentication challenge may be Rc. The third party local hub may transmit Rc to the third party authentication center shown by 1004 of FIG. 3. The third party authentication center may simultaneously generate a random number Rc1 to prepare to initiate challenge to the IoT device, and the third party authentication center can request challenge responses of Rc and Rc1 to the device cloud authentication center shown by 1002 of FIG. 3.

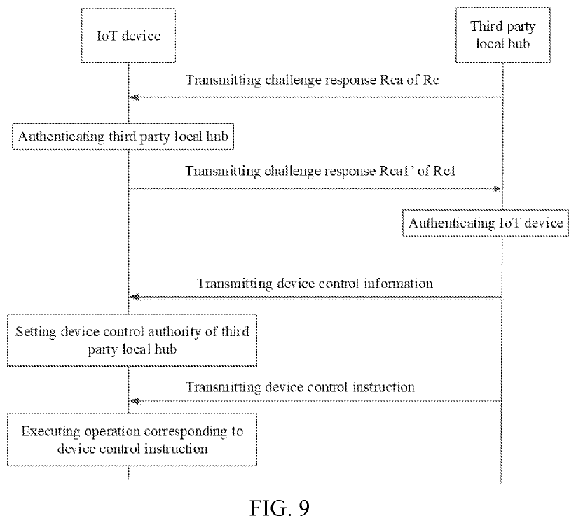

It should be noted that the third party authentication center and the device cloud authentication center can be authenticated through the TSL bidirectional certificates to confirm their identity. After having authenticated the identity, the device cloud authentication center can confirm the validity of the third party authentication center and return the challenge responses Rca and Rca1 to the third party authentication center. The third party authentication center may further return the Rca to the third party local hub. Further, the third party local hub may return Rca and Rc1 to the IoT device. As such, referring to FIG. 9, the IoT device may obtain the device authentication information Rca of the third party local hub.

At step 302, the first Internet of Things device may authenticate the second Internet of Things device based on the device authentication information of the second Internet of Things device.

As an example, the IoT device may authenticate the second Internet of Things device by comparing Rca with Rca′ calculated by the IoT device via Rc. Specifically, if the comparison result is consistent, the IoT device may determine that the third party local central hub is trusted, that is, the authentication is passed. Otherwise, the IoT device may determine that authentication of the third party local central hub fails.

At step 303, the second Internet of Things device may obtain device authentication information of the first Internet of Things device.

As an example, referring to FIG. 9, the IoT device may return the challenge response Rca1′ of Rc1 to the third party local hub to enable the third party local hub to obtain the device authentication information Rca1′ of the IoT device.

At step 304, the second Internet of Things device may authenticate the first Internet of Things device based on the device authentication information of the first Internet of Things device.

As an example, the IoT device may authenticate the IoT device by comparing Rca1′ with Rca1. Specifically, if the comparison result is consistent, the third party local central hub may determine that the IoT is trusted, that is, the authentication is passed. Otherwise, it can be determined that authentication of the IoT device fails.

At step 305, if the authentication of the second Internet of Things device to the first Internet of Things device is passed, then the second Internet of Things device transmits device control information to the first Internet of Things device, where the device control information is configured to instruct the first Internet of Things device to set a control authority, the control authority being a device control authority of the second Internet of Things device for the first Internet of Things device.

As an example, before the third party local hub transmits the device control information to the IoT device, the third party local hub may request to obtain a capability model of the IoT device from the IoT device in a pre-agreed format, and may specifically include a specific model, a type, a controllable instruction, an attribute, a service, and the like of the IoT device.

Further, the third party local hub may transmit a packet request to the IoT device in a pre-agreed format to request the IoT device to set the ACL. The ACL may include information such as an ecological identification code of the third party local hub, a device ID of the third party local hub, subject IDs, keys, roles, accessible services and an authority for each of the services, and an expiration time of the keys.

The ecological identification code may be used to uniquely identify a third party manufacturer. The device ID is a unique ID assigned by the ecology to the IoT device for uniquely identifying the IoT device within the ecology. The subject ID is used to uniquely identify a user or a controller within the third party manufacture, which is unique within the third party manufacture. The key is used for the controller to establish a secure encrypted connection with the IoT device, corresponding to the subject ID one by one. The roles represent different authorities, where an administrator can set an ACL again, while an ordinary user can only call an authorized service, corresponding to the subject ID one by one. It should be note that the third party local hub may allocate different subject IDs, keys, roles, etc. to different controllers and users within its own ecology.

At step 306, if the authentication of the first Internet of Things device to the second Internet of Things device is passed, the first Internet of Things device obtains device control information transmitted by the second Internet of Things device.

At step 307, the first Internet of Things device may set a device control authority of the second Internet of Things device for the first Internet of Things device based on the device control information.

At step 308, the second Internet of Things device transmits a device control instruction to the first Internet of Things to perform device control for the first Internet of Things via the device control instruction.

Alternatively, before the third party local hub transmits the device control instruction to the IoT, the IoT device performs security negotiation with the third party local hub through the subject ID and the key exchanged in the foregoing steps to establish the connection relationship. For purpose of distinguishing the connection relationship, the connection relationship established herein may be referred to as a control connection relationship.

The third party local hub may transmit a device control instruction to the IoT device in a pre-agreed packet by the connection relationship established in the foregoing steps, such as the configuration connection relationship or the control connection relationship, so as to call a service of the IoT device to control the IoT device.

It should be noted that, if the third party local hub has an administrator authority, a packet for setting an ACL may be periodically transmitted to update a key, so as to ensure the security. At the same time, the ACL can be modified through the interface when the authority is deleted or updated.

At step 309, the first Internet of Things device receives a device control instruction transmitted by the second Internet of Things device, where the device control instruction is used for the second Internet of Things device to perform device control for the first Internet of Things device.

At step 3010, the first Internet of Things device executes an operation corresponding to the device control instruction.

In the embodiments of the present application, the description of each of the embodiments has its own emphasis. For a part not described in detail in the explanation of a certain step or a certain term in a certain embodiment, reference may be made to the above detailed description of the method for setting the device control authority, which is not repeatedly described herein.

As can be seen from above that the solution can enable the second Internet of Things device that belongs to the different Internet of Things system than the first Internet of Things device to set the device control authority of the first Internet of Things device, thereby implementing device control in a scenario across the Internet of Things systems. Additionally, the solution can further authenticate the second Internet of Things device while setting the device control authority of the second Internet of Things device for the first Internet of Things device, thereby enhancing the security of device control. In addition, compared with the protocol interconnection or standardization between one cloud and another cloud or between an end and one cloud, the solution avoids the problem that the performance and the stability of the protocol interconnection or standardization between one cloud and another cloud are not high due to the long data link, and improves the problem that the device manufacturer of the protocol interconnection or standardization between an end and one cloud is less motivated and difficult to push because the Internet of Things device cannot access the cloud of the device manufacturer. As such, the solution can support that the Internet of Things devices are controlled by a local hub device such as a third-party application, a smart sound box, a gateway, a smart television, or a router without affecting the Internet of Things devices being connected to the cloud of the device manufacturer at a low cost, so that the interconnection and intercommunication between the Internet of Things devices across the Internet of Things systems are improved.

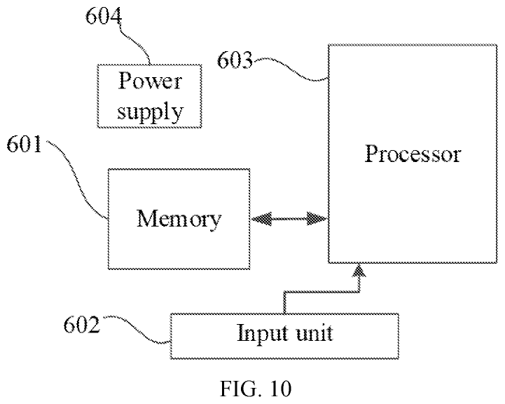

In addition, another embodiment of the present application further provides a computer device, which may be a device such as a terminal. As shown in FIG. 10, which shows a schematic structural diagram of the computer device according to some embodiments of the present application.

The computer device may include components such as a memory 601 including one or more computer readable storage media, an input unit 602, a processor 603 including one or more processing cores, and a power supply 604. It should be understood by those skilled in the art that the structure of the computer device shown in FIG. 10 should be not constituted to be a limitation on the computer device, and may include more or less components than illustrated, or may combine certain components, or different component arrangements.

The memory 601 may be used to store software programs and modules, and the processor 603 executes various functional applications and data processing by running the software programs and modules stored in the memory 601. The memory 601 may mainly include a storage program area and a storage data area, where the storage program area may store an operating system, an application program (such as a sound play function, an image play function, and the like) required by at least one function, and the like; and the storage data area may store data (such as audio data, a phone book, and the like) created according to use of a computer device, and the like. In addition, memory 601 may include a high speed random access memory, and may also include a non-volatile memory, such as at least one magnetic disk storage device, a flash memory device, or other volatile solid state storage device. Correspondingly, the memory 601 may further include a memory controller to provide access to the memory 601 by the processor 603 and the input unit 602.

The input unit 602 can be configured to receive input number or character information and to generate keyboard, mouse, joystick, optical or trajectory ball signal inputs related to a user's setting and functional control. In detail, in a specific embodiment, the input unit 602 can include a touch-sensitive surface and other input devices. The touch-sensitive surface, also called a touch display screen or a touch panel, can be configured to detect touch operations of a user on or near the touch-sensitive surface (for example, operations carried out by the user through any suitable objects or attachments, such as a finger, a touch pen and the like, on the touch-sensitive surface or near the touch-sensitive surface) and to drive a corresponding device connected therewith according to a preset program. Optionally, the touch-sensitive surface can include a touch detection device and a touch controller. The touch detection device detects the touch direction of the user, detects a signal caused by the touch operation, and transmits the signal to the touch controller. The touch controller receives touch information from the touch detection device, converts the touch information into a contact coordinate, and then transmits the contact coordinate to the processor 603 and can receive a command transmitted by the processor 603 and execute the command. Moreover, the touch-sensitive surface can be one of various types, such as a resistance type, a capacitance type, an infrared type, a surface acoustic wave type and the like. Besides the touch-sensitive surface, the input unit 602 can further include the other input devices. In detail, other input devices can include, but is not limited to, one or more of a physical keyboard, function keys (such as a volume control key, a switching key and the like), a trackball, a mouse, a joystick and the like.

The processor 603 is a control center of the computer device. The processor 603 is connected to various parts of the entire mobile phone by various interfaces and lines, and performs various functions of the computer device and processes data by running or executing software programs and/or modules stored in the memory 601 and invoking data stored in the memory 601, thereby monitoring the mobile phone as a whole. Alternatively, the processor 603 may include one or more processing cores. Preferably, the processor 603 may integrate an application processor and a modem processor, where the application processor mainly processes an operating system, a user interface, an application program, and the like, and the modem processor mainly processes wireless communication. It should be understood that the modulation/demodulation processor can be independent from the processor 603.

The computer device further includes a power supply 604 (such as a battery) for supplying power to the respective components. Preferably, the power supply may be logically connected to the processor 603 by the power supply management system, so that functions such as charging, discharging, and power consumption management are managed by the power supply management system. The power supply 604 may further include one or more direct current (DC)/or alternating current (AC) power sources, recharging system, power failure detection circuit, power converter or inverter, power supply status indicator, and the like.

Although not shown, the computer device may further include a camera, a BLUETOOTH module, and so on, which are not repeated herein. In the present embodiment, the processor 603 in the computer device may load executable files corresponding to processes of one or more application programs into the memory 601 according to the following instructions, and the processor 603 executes the application programs stored in the memory 601 to implement various functions including:
obtaining device authentication information of a second Internet of Things device that belongs to a different Internet of Things system from a first Internet of Things device; authenticating the second Internet of Things device based on the device authentication information of the second Internet of Things device; in response to the authentication being passed, obtaining device control information of the second Internet of Things device; and setting a device control authority of the second Internet of Things device for the first Internet of Things device based on the device control information.

Alternatively, the program instructions can perform following operations including:
obtaining device authentication information of a first Internet of Things device that belongs to a different Internet of Things system from a second Internet of Things device; authenticating the first Internet of Things device based on the device authentication information of the second Internet of Things device; and in response to the authentication being passed, transmitting device control information to the first Internet of Things device, where the device control information is configured to instruct the first Internet of Things device to set a control authority, the control authority being a device control authority of the second Internet of Things device for the first Internet of Things device.

Implementation of above operations may refer to above embodiments, and is not repeated herein.

As can be seen from above that the computer device of any of the embodiments can enable the second Internet of Things device that belongs to the different Internet of Things system than the first Internet of Things device to set the device control authority for the first Internet of Things device, thereby implementing device control in a scenario across the Internet of Things systems. Additionally, the computer device of any of the embodiments can further authenticate the second Internet of Things device while setting the device control authority of the second Internet of Things device for the first Internet of Things device, thereby enhancing the security of device control. In addition, compared with the protocol interconnection or standardization between one cloud and another cloud or between an end and one cloud, the computer device of any of the embodiments avoids the problem that the performance and the stability of the protocol interconnection or standardization between one cloud and another cloud are not high due to the long data link, and improves the problem that the device manufacturer of the protocol interconnection or standardization between an end and one cloud is less motivated and difficult to push because the Internet of Things device cannot access the cloud of the device manufacturer. As such, the computer device of any of the embodiments can support that the Internet of Things devices are controlled by a local hub device such as a third-party application, a smart sound box, a gateway, a smart television, or a router without affecting the Internet of Things devices being connected to the cloud of the device manufacturer at a low cost, so that the interconnection and intercommunication between the Internet of Things devices across the Internet of Things systems are improved.

A person of ordinary skill in the art may understand that all or some of the steps in various methods of the foregoing embodiments may be implemented by program instructions, or may be implemented by a program instructing relevant hardware. The program instructions may be stored in a computer readable storage medium, and be loaded and executed by a processor.

For this, another embodiment of the present application provides a storage medium, which stores a plurality of instructions that can be loaded by the processor to execute the steps of any of the methods provided in the embodiments of the present application. For example, the program instructions can perform following operations including:
obtaining device authentication information of a second Internet of Things device that belongs to a different Internet of Things system from a first Internet of Things device; authenticating the second Internet of Things device based on the device authentication information of the second Internet of Things device; in response to the authentication being passed, obtaining device control information of the second Internet of Things device; and setting a device control authority of the second Internet of Things device for the first Internet of Things device based on the device control information.

Alternatively, the program instructions can perform following operations including:
obtaining device authentication information of a first Internet of Things device that belongs to a different Internet of Things system from a second Internet of Things device; authenticating the first Internet of Things device based on the device authentication information of the second Internet of Things device; and in response to the authentication being passed, transmitting device control information to the first Internet of Things device, where the device control information is configured to instruct the first Internet of Things device to set a control authority, the control authority being a device control authority of the second Internet of Things device for the first Internet of Things device.

Implementation of above operations may refer to above embodiments, and is not repeated herein.

The storage medium may include a Read Only Memory (ROM), a Random Access Memory (RAM), a magnetic disk, an optical disk, or the like.

Since the computer program stored in the storage medium can perform the steps in any of the methods provided in the embodiments of the present application, the advantageous effects achieved by the method provided in the embodiments of the present application can be realized. Please refer to the foregoing embodiments, of which details are not repeatedly described herein.

According to one aspect of the present application, a computer program product or a computer program is provided, including a computer instruction stored in a computer readable storage medium. A processor of a computer device reads the computer instruction from the computer readable storage medium and executes the computer instruction to cause the computer device to perform any of the methods provided in the various alternative implementations described in the embodiments of the present application.

The method and apparatus for setting the device control authority, the computer device, and the storage medium provided in the embodiments of the present application are described in detail above. A specific example is used herein to describe a principle and an implementation of the present application. The description of the foregoing embodiments is merely used to help understand a method and a core idea of the present application. In addition, an ordinary person skilled in the art may make changes in a specific implementation manner and an application scope according to an idea of the present application. In conclusion, content of this specification should not be construed as a limitation on the present application.

What is claimed is:

1. A method for setting a device control authority, comprising:
obtaining device authentication information of a second Internet of Things device that belongs to a different Internet of Things system from a first Internet of Things device;
authenticating the second Internet of Things device based on the device authentication information of the second Internet of Things device;
in response to the authentication being passed, obtaining device control information of the second Internet of Things device; and
setting a device control authority of the second Internet of Things device for the first Internet of Things device based on the device control information.

2. The method of claim 1, wherein the authenticating of the second Internet of Things device based on the device authentication information of the second Internet of Things device comprises:
determining authentication verification information required for verifying the device authentication information; and
verifying the device authentication information based on the authentication verification information to authenticate the second Internet of Things device.

3. The method of claim 1, further comprising: before the obtaining of device control information of the second Internet of Things device comprises:
determining device capability information of the first Internet of Things device; and
transmitting the device capability information to the second Internet of Things device to trigger the second Internet of Things device to generate device control information for the first Internet of Things device based on the device capability information.

4. The method of claim 3, wherein the determining of device capability information of the first Internet of Things device comprises:
obtaining a device capability request of the second Internet of Things device for the first Internet of Things device; and
determining device capability information of the first Internet of Things device based on the device capability request.

5. The method of claim 1, wherein the device control information comprises a system identification of a target Internet of Things system and an object identification of a device control object, the target Internet of Things system is an Internet of Things system to which the second Internet of Things device belongs, and the device control object is an object that controls the first Internet of Things device via the second Internet of Things device;
the setting of device control authority of the second Internet of Things device for the first Internet of Things device based on the device control information comprises:
setting a device control authority of the device control object in the target Internet of Things system for the first Internet of Things device based on the system identification and the object identification.

6. The method of claim 5, wherein the device control information further comprises object attribute information of the device control object;
setting of the device control authority of the device control object in the target Internet of Things system for the first Internet of Things device based on the system identification and the object identification comprises:
determining a service calling authority of the device control object for the first Internet of Things device based on the object attribute information, wherein the service calling authority is a calling authority of the device control object for a service provided by the first Internet of Things device, and the service provided by the first Internet of Things device is determined based on the device capability information of the first Internet of Things device; and
setting a device control authority of the device control object in the target Internet of Things system for the first Internet of Things device based on the service calling authority.

7. The method of claim 6, wherein the setting of the device control authority of the device control object in the target Internet of Things system for the first Internet of Things device based on the service calling authority comprises:
in response to the object attribute information indicating that the device control object has an information changing authority for the first Internet of Things device, setting a device control authority of the device control object in the target Internet of Things system for the first Internet of Things device based on the information changing authority and the service calling authority, wherein the information changing authority represents a changing authority of the device control object for the device control information stored in the first Internet of Things device.

8. The method of claim 1, further comprising:
receiving a device control instruction transmitted by the second Internet of Things device, wherein the device control instruction is configured for the second Internet of Things device to perform device control for the first Internet of Things device; and
executing an operation corresponding to the device control instruction;
wherein the device control instruction comprises an information changing instruction;
the executing of the operation corresponding to the device control instruction comprises:
determining a device control object corresponding to the device control instruction; and
in response to the device control object having an information changing authority for the first Internet of Things device, executing an information changing operation corresponding to the information changing instruction.

9. A method for setting a device control authority, comprising:
obtaining device authentication information of a first Internet of Things device that belongs to a different Internet of Things system from a second Internet of Things device;
authenticating the first Internet of Things device based on the device authentication information of the first Internet of Things device; and
in response to the authentication being passed, transmitting device control information to the first Internet of Things device, wherein the device control information is configured to instruct the first Internet of Things device to set a control authority, the control authority being a device control authority of the second Internet of Things device for the first Internet of Things device.

10. The method of claim 9, wherein the authenticating of the first Internet of Things device based on the device authentication information of the first Internet of Things device comprises:
determining authentication verification information required for verifying the device authentication information; and
verifying the device authentication information based on the authentication verification information to authenticate the first Internet of Things device.

11. The method of claim 10, wherein the determining of the authentication verification information required for verifying the device authentication information comprises:
receiving authentication verification information transmitted by a second authentication server, wherein the authentication verification information is generated by a first authentication server based on first authentication challenge information, the first authentication server is a server paired with the first Internet of Things device, the second authentication server is a server paired with the second Internet of Things device, the first authentication server and the second authentication server are mutual authentication servers, and the first authentication challenge information is authentication challenge information of the second Internet of Things device for the first Internet of Things device.

12. The method of claim 9, further comprising: before the transmitting of the device control information to the first Internet of Things device comprises:
determining device capability information of the first Internet of Things device; and
generating device control information for the first Internet of Things device based on the device capability information.

13. The method of claim 12, wherein the determining of device capability information of the first Internet of Things device comprises:
generating a device capability request for the first Internet of Things device to transmit the device capability request to the first Internet of Things device; and
receiving device capability information returned by the first Internet of Things device based on the device capability request.

14. The method of claim 12, wherein the generating of the device control information for the first Internet of Things device based on the device capability information comprises:
determining a device control object of the second Internet of Things device, wherein the device control object is an object that controls the first Internet of Things device via the second Internet of Things device; and
generating device control information of the device control object in a target Internet of Things system for the first Internet of Things device based on the device capability information, wherein the target Internet of Things system is an Internet of Things system to which the second Internet of Things device belongs.

15. The method of claim 14, wherein the generating of the device control information of the device control object in the target Internet of Things system for the first Internet of Things device based on the device capability information comprises:
determining a service provided by the first Internet of Things device based on the device capability information;
determining service accessing information of the device control object for the service; and
generating device control information of the device control object in the target Internet of Things system for the first Internet of Things device based on the service accessing information, comprising:
determining object attribute information of the device control object; and
generating device control information of the device control object in the target Internet of Things system for the first Internet of Things based on the object attribute information.

16. The method of claim 9, further comprising:
transmitting a device control instruction to the first Internet of Things to perform device control for the first Internet of Things via the device control instruction.

17. An electronic device, comprising: a memory storing a computer program; and a processor, wherein the processor is configured to perform the computer program in the memory to perform the method of claim 1.

18. An electronic device, comprising: a memory storing a computer program; and a processor, wherein the processor is configured to perform the computer program in the memory to perform the method of claim 9.

19. A non-transitory computer readable storage medium storing a computer program which, when executed by a processor, causes the processor to perform the method of claim 1.

20. A non-transitory computer readable storage medium storing a computer program which, when executed by a processor, causes the processor to perform the method of claim 9.
